(19) United States
(12) Patent Application Publication
(10) Pub. No.: US 2024/0071289 A1
(43) Pub. Date: Feb. 29, 2024

(54) PIXEL CIRCUIT AND DRIVING METHOD THEREOF, DISPLAY PANEL AND DISPLAY DEVICE

(71) Applicant: Xiamen Tianma Display Technology Co., Ltd., Xiamen (CN)

(72) Inventor: Jieliang LI, Xiamen (CN)

(73) Assignee: Xiamen Tianma Display Technology Co., Ltd., Xiamen (CN)

(21) Appl. No.: 17/987,886

(22) Filed: Nov. 16, 2022

(30) Foreign Application Priority Data
Aug. 25, 2022 (CN) 202211026510.7

(51) Int. Cl. G09G 3/32

(52) U.S. Cl. CPC G09G 3/32; G09G 2300/0819; G09G 2300/0842; G09G 2310/0202; G09G 2310/0275; G09G 2310/06; G09G 2310/061; G09G 2310/08; G09G 2320/0247; G09G 2330/021

(57) ABSTRACT

The embodiments of the present application provide a pixel circuit and a driving method thereof, a display panel and a display device. The pixel circuit includes: a driving module; a first bias module configured to provide a first bias signal; wherein a light-emitting cycle of the light-emitting element comprises a refresh frame or a hold frame, each of the refresh frame and the hold frame comprises a first stage and a second stage, the first stage comprises one or more bias stages, and the second stage comprises a light-emitting stage, and wherein in the bias stages, the first bias module is turned on, and the first bias signal is transmitted to the driving module; wherein a turn-on duration of the first bias module in the hold frame is greater than a turn-on duration of the first bias module in the refresh frame.

### CROSS-REFERENCE TO RELATED APPLICATION

This application claims priority to Chinese Patent Application No. 202211026510.7, filed on Aug. 25, 2022, which is incorporated herein by reference in its entirety.

### TECHNICAL FIELD

The present application relates to a technical field of display, and particularly relates to a pixel circuit and a driving method thereof, a display panel and a display device.

### BACKGROUND

Currently, a display panel can be displayed with different refresh rates in different modes. For example, in a video mode or in a game mode, a driving mode with a high refresh rate can be used to drive the display panel to display dynamic pictures, thereby ensuring the fluency of the displayed pictures. For example, when some static pictures are displayed, a driving mode with a low refresh rate can be used to drive the display panel to display the static pictures, thereby reducing the power consumption.

The inventor of the present application has found that there is a problem of screen flashing when the display panel is displayed at a low refresh rate.

### SUMMARY

The embodiments of the present application provide a pixel circuit and a driving method thereof, a display panel and a display device.

In a first aspect, the embodiments of the present application provide a pixel circuit, including: a driving module configured to drive a light-emitting element to emit light; a first bias module electrically connected to a first terminal or a second terminal of the driving module, wherein the first bias module is configured to provide a first bias signal to the first terminal or the second terminal of the driving module, and the first bias signal is configured to adjust a bias state of the driving module; wherein a light-emitting cycle of the light-emitting element includes a refresh frame or a hold frame, wherein a control terminal of the driving module is refreshed in the refresh frame, and the control terminal of the driving module is not refreshed in the hold frame; each of the refresh frame and the hold frame includes a first stage and a second stage, the first stage is located before the second stage, the first stage includes one or more bias stages, and the second stage includes a light-emitting stage of the light-emitting element, and wherein in the bias stages, the first bias module is turned on, and the first bias signal is transmitted to the first terminal or the second terminal of the driving module; wherein a turn-on duration of the first bias module in the hold frame is longer than a turn-on duration of the first bias module in the refresh frame; and/or, a time interval between a turn-on start moment of the first bias module in the hold frame and the light-emitting stage in the hold frame is greater than a time interval between a turn-on start moment of the first bias module in the refresh frame and the light-emitting stage in the refresh frame; and/or a turn-on stage of the first bias module in the refresh frame at least partially overlaps with other bias stages in the refresh frame.

In a second aspect, the embodiments of the present application provide a driving method of a pixel circuit, wherein the pixel circuit includes: a driving module configured to drive a light-emitting element to emit light; a first bias module electrically connected to a first terminal or a second terminal of the driving module, wherein the first bias module is configured to provide a first bias signal to the first terminal or the second terminal of the driving module, and the first bias signal is configured to adjust a bias state of the driving module; wherein a light-emitting cycle of the light-emitting element includes a refresh frame or a hold frame, wherein a control terminal of the driving module is refreshed in the refresh frame, and the control terminal of the driving module is not refreshed in the hold frame; each of the refresh frame and the hold frame includes a first stage and a second stage, the first stage is located before the second stage, the first stage includes one or more bias stages, and the second stage includes a light-emitting stage of the light-emitting element; the driving method includes: in the bias stages, controlling the first bias module to be turned on, and transmitting the first bias signal to the first terminal or the second terminal of the driving module; wherein a turn-on duration of the first bias module in the hold frame is longer than a turn-on duration of the first bias module in the refresh frame; and/or, a time interval between a turn-on start moment of the first bias module in the hold frame and the light-emitting stage in the hold frame is greater than a time interval between a turn-on start moment of the first bias module in the refresh frame and the light-emitting stage in the refresh frame; and/or a turn-on stage of the first bias module in the refresh frame at least partially overlaps with other bias stages in the refresh frame.

In a third aspect, the embodiments of the present application provide a display panel including the pixel circuit provided in the first aspect.

In a fourth aspect, the embodiments of the present application provide a display device including the display panel provided in the third aspect.

### BRIEF DESCRIPTION OF THE DRAWINGS

In order to illustrate technical solutions of embodiments of the present application more clearly, the drawings required for the embodiments of the present application will be briefly described. For a person skilled in the art, other drawings can also be obtained from these drawings without any inventive efforts.

FIG. 1 is a schematic diagram of a shift of an Id-Vg curve of a driving module in a pixel circuit;

FIG. 2 is a circuit diagram of a pixel circuit provided by an embodiment of the present application;

FIG. 3 is a time sequence diagram of a pixel circuit provided by an embodiment of the present application;

FIG. 4 is another time sequence diagram of a pixel circuit provided by an embodiment of the present application;

FIG. 5 is another time sequence diagram of a pixel circuit provided by an embodiment of the present application;

FIG. 6 is another time sequence diagram of a pixel circuit provided by an embodiment of the present application;

FIG. 7 is another time sequence diagram of a pixel circuit provided by an embodiment of the present application;

FIG. 8 is another time sequence diagram of a pixel circuit provided by an embodiment of the present application;

FIG. 9 is another circuit diagram of a pixel circuit provided by an embodiment of the present application;

FIG. 10 is another circuit diagram of a pixel circuit provided by an embodiment of the present application;

FIG. 11 is another time sequence diagram of a pixel circuit provided by an embodiment of the present application;

FIG. 12 is another time sequence diagram of a pixel circuit provided by an embodiment of the present application;

FIG. 13 is another circuit diagram of a pixel circuit provided by an embodiment of the present application;

FIG. 14 is another time sequence diagram of a pixel circuit provided by an embodiment of the present application;

FIG. 15 is another time sequence diagram of a pixel circuit provided by an embodiment of the present application;

FIG. 16 is another circuit diagram of a pixel circuit provided by an embodiment of the present application;

FIG. 17 is another time sequence diagram of a pixel circuit provided by an embodiment of the present application;

FIG. 18 is another circuit diagram of a pixel circuit provided by an embodiment of the present application;

FIG. 19 is another time sequence diagram of a pixel circuit provided by an embodiment of the present application;

FIG. 20 is another circuit diagram of a pixel circuit provided by an embodiment of the present application;

FIG. 21 is another time sequence diagram of a pixel circuit provided by an embodiment of the present application;

FIG. 22 is another time sequence diagram of a pixel circuit provided by an embodiment of the present application;

FIG. 23 is another circuit diagram of a pixel circuit provided by an embodiment of the present application;

FIG. 24 is another time sequence diagram of a pixel circuit provided by an embodiment of the present application;

FIG. 25 is another time sequence diagram of a pixel circuit provided by an embodiment of the present application;

FIG. 26 is another time sequence diagram of a pixel circuit provided by an embodiment of the present application;

FIG. 27 is another time sequence diagram of a pixel circuit provided by an embodiment of the present application;

FIG. 28 is another circuit diagram of a pixel circuit provided by an embodiment of the present application;

FIG. 29 is another time sequence diagram of a pixel circuit provided by an embodiment of the present application;

FIG. 30 is another circuit diagram of a pixel circuit provided by an embodiment of the present application;

FIG. 31 is another time sequence diagram of a pixel circuit provided by an embodiment of the present application;

FIG. 32 is a flow diagram of a driving method of a pixel circuit provided by an embodiment of the present application;

FIG. 33 is another flow diagram of a driving method of a pixel circuit provided by an embodiment of the present application;

FIG. 34 is another flow diagram of a driving method of a pixel circuit provided by an embodiment of the present application;

FIG. 35 is a structural diagram of a display panel provided by an embodiment of the present application;

FIG. 36 is a structural diagram of a display device provided by an embodiment of the present application.

### DETAILED DESCRIPTION

The features and exemplary embodiments of various aspects of the present application will be described in detail below. In order to make the purpose, technical solutions and advantages of the present application more clear, the present application will be further described in detail below with reference to the accompanying drawings and specific embodiments. It should be understood that the specific embodiments described herein are only intended to explain the present application, but not to limit the present application. It will be apparent to a person skilled in the art that the present application may be practiced without some of these specific details. The following description of the embodiments is merely to provide a better understanding of the present application by illustrating examples of the present application.

It should be noted that, in this document, relational terms such as first and second are used only to distinguish one entity or operation from another entity or operation, and do not necessarily require or imply such an actual relationship or sequence between these entities or operations. Moreover, the terms “including”, “including” or any other variation thereof are intended to encompass a non-exclusive inclusion such that a process, method, article or device that includes a list of elements includes not only those elements, but also includes other elements that are not explicitly listed but inherent to such a process, method, article or device. Without further limitation, an element defined by the term “including . . . ” does not preclude presence of additional elements in a process, method, article or device that includes the element.

It should be understood that the term “and/or” used herein is just a related relationship that describes associated objects, and indicates that there can be three relationships. For example, A and/or B may indicate three cases: A alone, A and B, and B alone. In addition, the character “/” used herein generally indicates that the relationship between the front and back associated objects is a “or” relationship.

It should be noted that the transistor in the embodiments of the present application may be an N-type transistor or a P-type transistor. For the N-type transistor, the turn-on level is a high level, and the turn-off level is a low level. That is, under a condition that the gate of the N-type transistor is at the high level, the first electrode and the second electrode of the N-type transistor are turned on. Further, under a condition that the gate of the N-type transistor is at the low level, the first electrode and the second electrode of the N-type transistor are turned off. For the P-type transistor, the turn-on level is a low level, and the turn-off level is a high level. That is, under a condition that the gate of the P-type transistor is at the low level, the first electrode and the second electrode of the P-type transistor are turned on. Further, under a condition that the gate of the P-type transistor is at the high level, the first electrode and the second electrode of the P-type transistor are turned off. In specific implementations, the gate of the transistor may be used as the control electrode. Further, according to the signal of the gate of the transistor and the type of the transistor, the first electrode may be the source and the second electrode may be the drain, or the first electrode may be the drain and the second electrode may be the source, which is not limited here. In addition, the turn-on level and the turn-off level in the embodiments of the present application are generalized, the turn-on level may refer to any level that can turn on the transistor, and the turn-off level may refer to any level that can turn off the transistor.

In the embodiments of the present application, the term “electrically connected” may indicate that the two components are directly electrically connected, or may indicate that the two components are electrically connected through one or more other components.

In the embodiments of the present application, a first node, a second node, and a third node are defined only to facilitate the description of the circuit structure. Further, the first node, the second node, and the third node are not actual circuit units.

It is obvious to those skilled in the art that various modifications and changes can be made in the present application without departing from the spirit or scope of the present application. Therefore, the present application is intended to cover the modifications and changes of the present application within the scope of the corresponding claims (the claimed technical solutions) and their equivalents. It should be noted that the implementations provided by the embodiments of the present application may be combined with each other without contradiction.

Before explaining the technical solutions provided by the embodiments of the present application, in order to facilitate the understanding of the embodiments of the present application, the present application firstly describes the problems existing in the related art.

As mentioned above, the inventor of the present application found that in the related art, there is a problem of screen flashing when the display panel is displayed at a low refresh rate.

In order to solve the above technical problem, the inventor of the present application has firstly conducted research and analysis of the root causes of the above technical problem. The specific research and analysis process is as follows.

When the display panel is displayed at a low refresh rate, a refresh cycle may include a refresh frame and a hold frame. In the hold frame, the control terminal of the driving module in the pixel circuit does not refresh, thereby reducing the power consumption. Here, for example, the low refresh rate may include a refresh rate of 1 Hz, 2 Hz, 10 Hz or other Hertz, which is not limited by the embodiments of the present application.

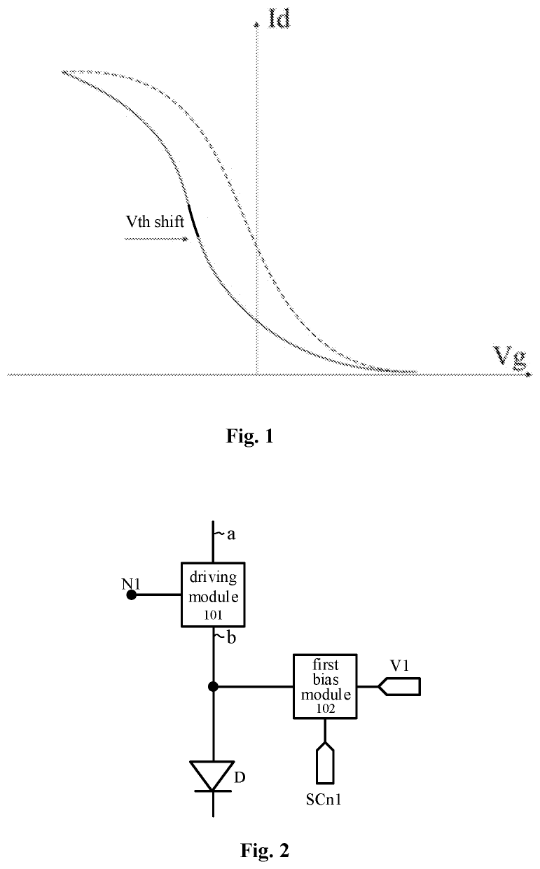

The inventor of the present application has made the following researches. FIG. 1 is a schematic diagram of a shift of an Id-Vg curve of a driving module in a pixel circuit. As shown in FIG. 1, in a non-bias stage such as the light-emitting stage of the pixel circuit, the potential of the control terminal of the driving module may be greater than the potential of the second terminal of the driving module. Long-term such settings will lead to ion polarization inside the driving module, which then forms an internal electric field inside the driving module, resulting in the increasing threshold voltage Vth of the driving module and the shift of the Id-Vg curve. Thus, the driving current flowing into the light-emitting element may be affected, and the display uniformity may be affected. For example, when a black picture is switched to a white picture, the display brightness will be increased slowly up, and it needs to experience 4-5 frames of data refresh for the brightness to be stabilized. Because the recovery time is long, the human eye can detect the screen flashing.

In order to improve the problem of the first frame having low brightness caused by shift of the threshold voltage Vth of the driving module, a bias stage can be added to the refresh frame. Therefore, the potential of the second terminal of the driving module is equal to or greater than the potential of the control terminal of the driving module, and the driving module is in the on-bias (OBS) state. Further, the potential difference between the potential of the second terminal of the driving module and the potential of the control terminal of the driving module may be improved, and the extent of ion polarization inside the driving module may be weakened. Thus, the threshold voltage Vth of the driving module may be reduced, thereby adjusting the threshold voltage Vth of the driving module.

However, in this way, the time period that the driving module is in the OBS state in the refresh frame is greater than the time period that the driving module is in the OBS state in the hold frame. Further, the difference between the threshold voltage Vth of the driving module in the refresh frame and the threshold voltage Vth of the driving module in the hold frame is large. Therefore, the difference between the brightness of the refresh frame and the brightness of the hold frame is large, thereby causing the flashing problem of the display panel.

In view of the above research findings of the inventor, the embodiments of the present application provide a pixel circuit and a driving method thereof, a display panel and a display device, which can solve the technical problem of screen flashing when the display panel is displayed at the low refresh rate in the related art.

The technical idea of the embodiments of the present application is that: by increasing the turn-on duration of the first bias module in the hold frame, and/or increasing the time interval between the turn-on start moment of the first bias module in the hold frame and the light-emitting stage in the hold frame, and/or at least partially overlapping the turn-on stage of the first bias module in the refresh frame with other bias stages in the refresh frame, the time period that the driving module is in the on-bias state in the hold frame may be increased and/or the time period that the driving module is in the on-bias state in the refresh frame may be reduced. Further, the difference between the threshold voltage of the driving module in the hold frame and the threshold voltage of the driving module in the refresh frame may be improved, the difference between the brightness of the refresh frame and the brightness of the hold frame may be reduced, and the flashing problem may be improved.

The pixel circuit provided by the embodiments of the present application is firstly introduced below.

FIG. 2 is a circuit diagram of a pixel circuit provided by an embodiment of the present application. As shown in FIG. 2, the pixel circuit 10 provided by the embodiment of the present application may include a driving module 101 and a first bias module 102. A control terminal of the driving module 101 is electrically connected to a first node N1, and the driving module 101 may be configured to drive a light-emitting element D to emit light. Here, the light-emitting element D includes, but is not limited to, an organic light-emitting diode (OLED), a mini light-emitting diode (Mini LED), a micro light-emitting diode (Micro LED), or a quantum dot light-emitting diode (QLED). The first bias module 102 is electrically connected to a first terminal or a second terminal of the driving module 101, and the first bias module 102 may be configured to provide a first bias signal to the first terminal or the second terminal of the driving module 101. The first bias signal may be configured to adjust a bias state of the driving module 101. That is, the potential of the second terminal of the driving module 101 may be equal to or greater than the potential of the control terminal of the driving module 101, so that the driving module 101 is in the OBS state, thereby realizing the adjustment of the threshold voltage Vth of the driving module 101.

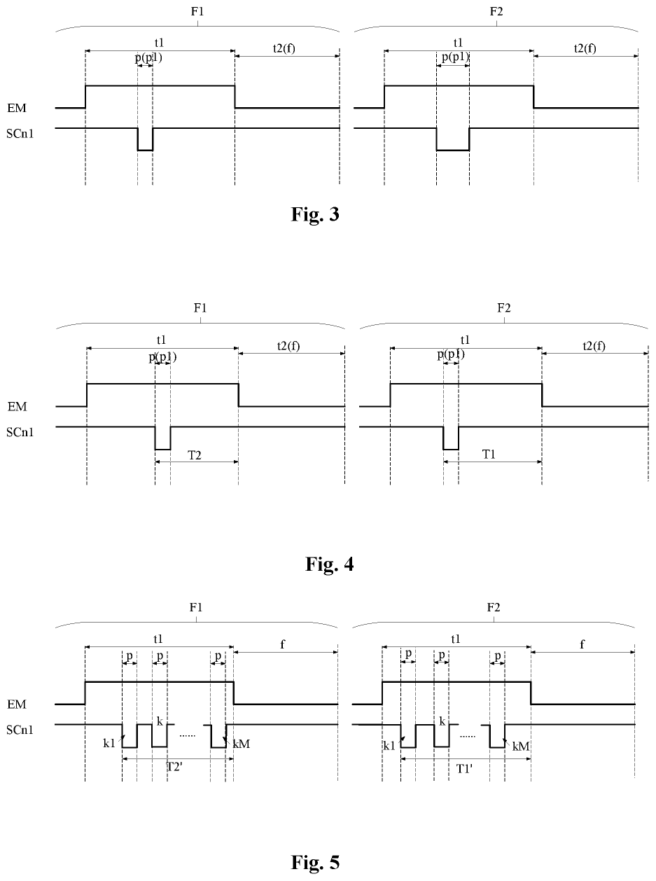

FIG. 3 is a time sequence diagram of a pixel circuit provided by an embodiment of the present application. As shown in FIG. 3, a light-emitting cycle of the light-emitting element may include a refresh frame F1 or a hold frame F2. Here, the light-emitting cycle can be understood as a frame, that is, the light-emitting cycle can include a non-light-emitting stage and a light-emitting stage. In the non-light-emitting stage, the light-emitting element does not emit light; and in the light-emitting stage, the light-emitting element emits light. For example, for a 7T1C pixel circuit, the non-light-emitting stage may be a stage when the light-emitting control signal Emit is at a turn-off level (e.g., a high level), and the light-emitting stage may be a stage when the light-emitting control signal Emit is at a turn-on level (e.g., a low level).

Combining FIGS. 2 and 3, a control terminal of the driving module 101 is refreshed in the refresh frame F1, that is, the potential of the control terminal of the driving module 101 is changed in the refresh frame F1, such as the potential of the control terminal of the driving module 101 decreases firstly and then increases. The control terminal of the driving module 101 is not refreshed in the hold frame F2, so that the power consumption can be reduced. Both the refresh frame F1 and the hold frame F2 may include a first stage t1 and a second stage t2, and the first stage t1 is located before the second stage t2. The first stage t1 includes one or more bias stages p, and the second stage t2 may include a light-emitting stage f of the light-emitting element.

In the bias stages p, the first bias module 102 is turned on (or switched on), and the first bias signal is transmitted to the first terminal a or the second terminal b of the driving module 101. It should be noted that in the bias stages p, the driving module 101 may be in the turn-on state. Therefore, whether the first bias signal is transmitted to the first terminal a of the driving module 101 or the second terminal b of the driving module 101, the first bias signal can eventually be transmitted to the second terminal b of the driving module 101. It should be noted that in FIG. 2, the second terminal of the first bias module 102 is electrically connected to the second terminal b of the driving module 101, but it is understood that the second terminal of the first bias module 102 can also be electrically connected to the first terminal a of the driving module 101. In some specific examples, the driving module 101 may be a thin film transistor (TFT), and one of the first terminal a and the second terminal b of the driving module 101 may be the source of the thin film transistor, and the other one may be the drain of the thin film transistor.

The potential of the control terminal of the driving module 101 is usually negative, that is, less than 0V Therefore, in some embodiments, the voltage value of the first bias signal may be greater than 0V or may be negative, but it needs to be greater than or equal to the potential of the control terminal of the driving module 101.

After the first bias signal is transmitted to the second terminal b of the driving module 101, and until before the light-emitting stage, the driving module 101 is in the OBS state, thereby achieving the adjustment of the threshold voltage Vth of the driving module 101.

Combining FIGS. 2 and 3, for ease of illustration, the low level indicates that the first bias module 102 is turned on. A turn-on duration of the first bias module 102 in the hold frame F2 may be greater than a turn-on duration of the first bias module 102 in the refresh frame F1. That is, by increasing the turn-on duration of the first bias module 102 in the hold frame F2, the time period that the driving module is in the OBS state in the hold frame F2 may be increased. Therefore, the difference between the time period that the driving module is in the OBS state in the hold frame F2 and the time period that the driving module is in the OBS state in the refresh frame F1 may be improved. Further, the difference between the threshold voltage of the driving module in the hold frame F2 and the threshold voltage of the driving module in the refresh frame F1 may be improved, the difference between the brightness of the refresh frame F1 and the brightness of the hold frame F2 may be reduced, and the flashing problem may be improved.

FIG. 4 is another time sequence diagram of a pixel circuit provided by an embodiment of the present application. As shown in FIG. 4, in the embodiment of the present application, the turn-on duration of the first bias module 102 in the hold frame F2 may also be equal to the turn-on duration of the first bias module 102 in the refresh frame F1. However, a time interval T1 between a turn-on start moment of the first bias module 102 in the hold frame F2 and the light-emitting stage in the hold frame F2 is greater than a time interval T2 between a turn-on start moment of the first bias module 102 in the refresh frame F1 and the light-emitting stage in the refresh frame F1. During the duration of either T1 or T2, the driving module 101 maintains in the OBS state (i.e., the potential of the second terminal of the driving module 101 is equal to or greater than the potential of the control terminal of the driving module 101).

Thus, by increasing the time interval between the turn-on start moment of the first bias module in the hold frame F2 and the light-emitting stage in the hold frame F2, the time period that the driving module is in the OBS state in the hold frame F2 may be increased. Therefore, the difference between the time period that the driving module is in the OBS state in the hold frame F2 and the time period that the driving module is in the OBS state in the refresh frame F1 may be improved. Further, the difference between the threshold voltage of the driving module in the hold frame F2 and the threshold voltage of the driving module in the refresh frame F1 may be improved, the difference between the brightness of the refresh frame F1 and the brightness of the hold frame F2 may be reduced, and the flashing problem may be improved.

Continuing referring to FIG. 2, according to some embodiments of the present application, a control terminal of the first bias module 102 may be electrically connected to a first scan signal terminal Scn1, a first terminal of the first bias module 102 may be electrically connected to a first bias signal terminal V1, and a second terminal of the first bias module 102 may be electrically connected to the first terminal a or the second terminal b of the driving module 101. Under a control of a first scan signal provided by the first scan signal terminal Scn1, the first bias module 102 may be turned on, and may transmit the first bias signal provided by the first bias signal terminal VT to the first terminal a or the second terminal b of the driving module 101. As described above, optionally, under a condition that the driving module 101 is a thin film transistor, one of the first terminal a and the second terminal b of the driving module 101 may be a source of the thin film transistor, and the other one may be a drain of the thin film transistor. Combining FIG. 2, 3 or 4, in some specific embodiments, in the refresh frame F1 and the hold frame F2, the bias stages p may include a first bias stage p1. In the first bias stage p1, the first bias module 102 is turned on, and the first bias signal is transmitted to the first terminal a or the second terminal b of the driving module 101, thereby adjusting the threshold voltage of the driving module 101. Specifically, in the first bias stage p1, the first scan signal terminal Scn1 may output a turn-on level, and the first bias module 102 is turned on in response to the turn-on level output by the first scan signal terminal Scn1. The first bias signal provided by the first bias signal terminal V1 is transmitted to the first terminal a or the second terminal b of the driving module 101 through the turned-on first bias module 102, so that the driving module 101 is in the OBS state, thereby realizing the adjustment of the threshold voltage of the driving module 101.

In some specific embodiments, the duration of the first bias stage p1 in the hold frame F2 may be greater than the duration of the first bias stage p1 in the refresh frame F1, and/or the time interval between the first bias stage p1 in the hold frame F2 and the light-emitting stage f in the hold frame F2 may be greater than the time interval between the first bias stage p1 in the refresh frame F1 and the light-emitting stage f in the refresh frame F1.

Thus, by increasing the duration of the first bias stage p1 in the hold frame F2, and/or increasing the time interval between the first bias stage p1 in the hold frame F2 and the light-emitting stage in the hold frame F2, the time period that the driving module is in the OBS state in the hold frame F2 may be increased. Therefore, the difference between the time period that the driving module is in the OBS state in the hold frame F2 and the time period that the driving module is in the OBS state in the refresh frame F1 may be improved. Further, the difference between the threshold voltage of the driving module in the hold frame F2 and the threshold voltage of the driving module in the refresh frame F1 may be improved, the difference between the brightness of the refresh frame F1 and the brightness of the hold frame F2 may be reduced, and the flashing problem may be improved.

FIG. 5 is another time sequence diagram of a pixel circuit provided by an embodiment of the present application. Combining FIGS. 2 and 5, according to some embodiments of the present application, optionally, in the refresh frame F1 and the hold frame F2, the first scan signal may include one or more pulses k for controlling the first bias module 102 to be turned on, that is, the pulses k may be referred as turn-on pulses. Specifically, the first scan signal may include 1^{st} to M^{th} pulses k arranged at intervals in time sequence, recorded as k1 to kM, where M is a positive integer. Here, k1 represents the 1^{st} pulse k, and kM represents the M^{th} pulse k. For example, M may be equal to 1, or may be greater than or equal to 2, which is not limited by the embodiments of the present application.

To facilitate illustration, a time interval between a turn-on moment of the 1^{st} pulse k1 of the first scan signal in the hold frame F2 and the light-emitting stage in the hold frame F2 is referred to as a first time interval T1′, and a time interval between a turn-on moment of the 1^{st} pulse k1 of the first scan signal in the refresh frame F1 and the light-emitting stage in the refresh frame F1 is referred to as a second time interval T2′. Under a condition that the first scan signal is a low level and the first bias module is turned on (or switched on), the first time interval T1′ may refer to the time interval between a falling edge of the 1^{st} pulse k1 of the first scan signal in the hold frame F2 and the light-emitting stage in the hold frame F2, and the second time interval T2′ may refer to the time interval between a falling edge of the 1^{st} pulse k1 of the first scan signal in the refresh frame F1 and the light-emitting stage in the refresh frame F1. Here, the first time interval T1′ is greater than the second time interval T2′.

Thus, by increasing the time interval between the turn-on moment of the 1^{st} pulse k1 of the first scan signal in the hold frame F2 and the light-emitting stage in the hold frame F2 (that is, the first time interval T1′), the time period that the driving module is in the OBS state in the hold frame F2 may be increased. Therefore, the difference between the time period that the driving module is in the OBS state in the hold frame F2 and the time period that the driving module is in the OBS state in the refresh frame F1 may be improved. Further, the difference between the threshold voltage of the driving module in the hold frame F2 and the threshold voltage of the driving module in the refresh frame F1 may be improved, the difference between the brightness of the refresh frame F1 and the brightness of the hold frame F2 may be reduced, and the flashing problem may be improved.

Continuing referring to FIG. 5, according to some embodiments of the present application, a width of the pulse k in the hold frame F2 may be equal to a width of the pulse k in the refresh frame F1. As mentioned above, the pulses k are the turn-on pulses, which can control the first bias module 102 (and the TFT in the first bias module 102) to be turned on, and the width of the pulse is understood as the duration. Similarly, the width of the pulse below can also be understood as the duration, which will not be repeated below for the sake of simplicity. Specifically, the width of each pulse k in the hold frame F2 may be equal to the width of each pulse k in the refresh frame F1. For example, the width of each pulse k in the hold frame F2 is Δt, and similarly, the width of each pulse k in the refresh frame F1 may also be Δt. That is, in the embodiment shown in FIG. 5, the turn-on duration of the first bias module in the hold frame F2 may be equal to the turn-on duration of the first bias module in the refresh frame F1. However, since the first time interval T1′ is greater than the second time interval T2′, the time period that the driving module is in the OBS state in the hold frame F2 may also be increased. Therefore, the difference between the brightness of the refresh frame F1 and the brightness of the hold frame F2 may be reduced, and the flashing problem may be improved. That is, in the hold frame F2, entering into the turn-on stage of SCn1 may be earlier. In this way, the compensation for the difference between the time period that the driving module is in the OBS state in the hold frame F2 and the time period that the driving module is in the OBS state in the refresh frame F1 (OBS time difference for short) may be started earlier. On one hand, sufficient time can be left to compensate for the OBS time difference. On the other hand, the supplementary pulse k in the hold frame F2 (i.e., the turn-on time period of SCn1 added in the hold frame F2) can be prevented from being too close to the light-emitting stage f and affecting other time periods in the frame.

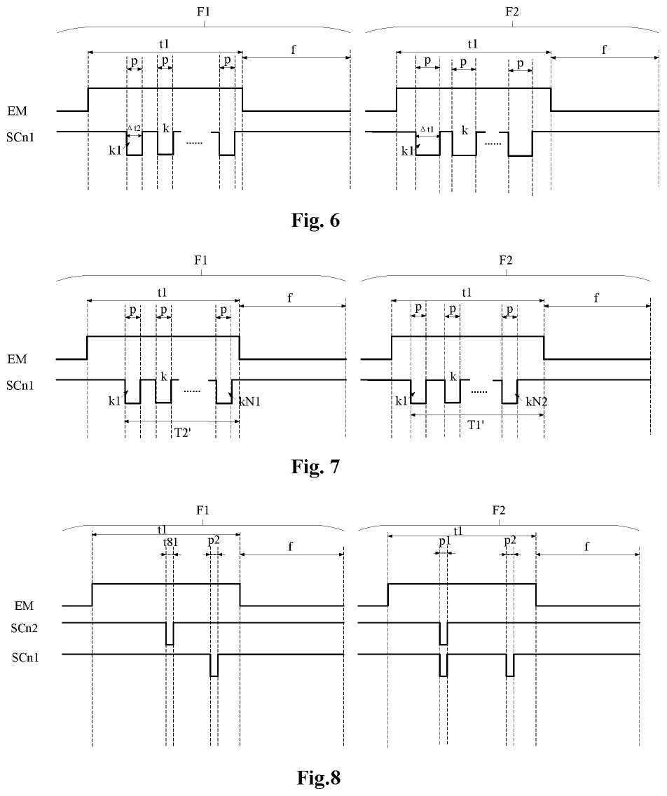

FIG. 6 is another time sequence diagram of a pixel circuit provided by an embodiment of the present application. Combining FIGS. 2 and 6, according to some other embodiments of the present application, optionally, in the refresh frame F1 and the hold frame F2, the first scan signal may include one or more pulses k for controlling the first bias module 102 to be turned on, that is, the pulses k may be referred to as turn-on pulses. Here, the number of the pulses k of the first scan signal in the hold frame F2 may be equal to or unequal to the number of the pulses k of the first scan signal in the refresh frame F1. In the embodiment illustrated in FIG. 6, a width of at least one of the pulses k in the hold frame F2 may be greater than a width of any one of the pulses k in the refresh frame F1. For example, the width of the 1^{st} pulse k1 of the first scan signal in the hold frame F2 may be greater than the width of the 1^{st} pulse k1 of the first scan signal in the refresh frame F1. Of course, it is also possible that the width of each pulse k of the first scan signal in the hold frame F2 is greater than the width of each pulse k of the first scan signal in the refresh frame F1. For example, the width of each pulse k in the hold frame F2 is Δt1, the width of each pulse k in the refresh frame F1 is Δt2, and Δt1>Δt2.

Thus, the turn-on duration of the first bias module in the hold frame F2 may be greater than the turn-on duration of the first bias module in the refresh frame F1. That is, by increasing the turn-on duration of the first bias module in the hold frame F2, the time period that the driving module is in the OBS state in the hold frame F2 may be increased. Therefore, the difference between the time period that the driving module is in the OBS state in the hold frame F2 and the time period that the driving module is in the OBS state in the refresh frame F1 may be improved. Further, the difference between the threshold voltage of the driving module in the hold frame F2 and the threshold voltage of the driving module in the refresh frame F1 may be improved, the difference between the brightness of the refresh frame F1 and the brightness of the hold frame F2 may be reduced, and the flashing problem may be improved.

FIG. 7 is another time sequence diagram of a pixel circuit provided by an embodiment of the present application. Combining FIGS. 2 and 7, according to some other embodiments of the present application, optionally, in the refresh frame F1, the first scan signal may include N1 pulses k for controlling the first bias module 102 to be turned on, and the N1 pulses k may be arranged at intervals in time sequence, recorded as k1 to kN1, where N1 is a positive integer. Here, k1 represents the 1st pulse k, and kN1 represents the N1^{th} pulse k. In the hold frame F2, the first scan signal may include N2 pulses k for controlling the first bias module 102 to be turned on, and the N2 pulses k may be arranged at intervals in time sequence, recorded as k1 to kN2, where N2>N1 and N2 is a positive integer. Here, k1 represents the V pulse k, and kN2 represents the N2^{th} pulse k.

That is, the number of the pulses k of the first scan signal in the hold frame F2 may be greater than the number of the pulses k of the first scan signal in the refresh frame F1. For example, in some specific examples, the number of the pulses k of the first scan signal in the hold frame F2 is 3, and the number of the pulses k of the first scan signal in the refresh frame F1 is 2.

Since the number of the pulses k of the first scan signal in the hold frame F2 is greater than the number of the pulses k of the first scan signal in the refresh frame F1, the turn-on duration of the first bias module in the hold frame F2 may be greater than the turn-on duration of the first bias module in the refresh frame F1. Thus, by increasing the turn-on duration of the first bias module in the hold frame F2, the time period that the driving module is in the OBS state in the hold frame F2 may be increased. Therefore, the difference between the time period that the driving module is in the OBS state in the hold frame F2 and the time period that the driving module is in the OBS state in the refresh frame F1 may be improved. Further, the difference between the threshold voltage of the driving module in the hold frame F2 and the threshold voltage of the driving module in the refresh frame F1 may be improved, the difference between the brightness of the refresh frame F1 and the brightness of the hold frame F2 may be reduced, and the flashing problem may be improved.

It should be noted that in the embodiment shown in FIG. 7, the width of the pulse k in the hold frame F2 may be equal to the width of the pulse k in the refresh frame F1. Of cause, the width of the pulse k in the hold frame F2 may be unequal to the width of the pulse k in the refresh frame F1. For example, the width of the pulse k in the hold frame F2 may be greater than the width of the pulse k in the refresh frame F1, which is not limited in the embodiment of the present application.

Referring further to FIG. 7, in some specific embodiments, optionally, to facilitate illustration, a time interval between a turn-on moment of the 1^{st} pulse k1 of the first scan signal in the hold frame F2 and the light-emitting stage in the hold frame F2 is referred to as a first time interval T1′, and a time interval between a turn-on moment of the 1^{st} pulse k1 of the first scan signal in the refresh frame F1 and the light-emitting stage in the refresh frame F1 is referred to as a second time interval T2′. Under a condition that the first scan signal is a low level and the first bias module is turned on (or switched on), the first time interval T1′ may refer to the time interval between a falling edge of the 1^{st} pulse k1 of the first scan signal in the hold frame F2 and the light-emitting stage in the hold frame F2, and the second time interval T2′ may refer to the time interval between a falling edge of the 1^{st} pulse k1 of the first scan signal in the refresh frame F1 and the light-emitting stage in the refresh frame F1. Here, the first time interval T1′ is greater than the second time interval T2′.

Thus, not only the turn-on duration of the first bias module in the hold frame F2 is greater than the turn-on duration of the first bias module in the refresh frame F1, but also the first time interval T1′ is greater than the second time interval T2′. That is, the turn-on duration of the first bias module in the hold frame F2 is increased, meanwhile the time interval between the turn-on moment of the 1^{st} pulse k1 of the first scan signal in the hold frame F2 and the light-emitting stage in the hold frame F2 (that is, the first time interval T1′) is increased. Thus, the time period that the driving module is in the OBS state in the hold frame F2 may be increased in two ways. Therefore, the difference between the time period that the driving module is in the OBS state in the hold frame F2 and the time period that the driving module is in the OBS state in the refresh frame F1 may be improved. Further, the difference between the threshold voltage of the driving module in the hold frame F2 and the threshold voltage of the driving module in the refresh frame F1 may be improved, the difference between the brightness of the refresh frame F1 and the brightness of the hold frame F2 may be reduced, and the flashing problem may be improved.

FIG. 8 is another time sequence diagram of a pixel circuit provided by an embodiment of the present application. Combining FIGS. 2 and 8, according to some embodiments of the present application, optionally, the first stage t1 of the refresh frame F1 may further include a data writing stage t81. In the data writing stage t81, a data signal may be written to the driving module 101, and the potential of the control terminal of the driving module 101 may be changed. The voltage value of the data signal may affect the magnitude of the driving current flowing through the driving module 101, and then may affect the brightness of the light-emitting element D. Thus, by controlling the voltage value of the data signal, the brightness of the light-emitting element D can be controlled.

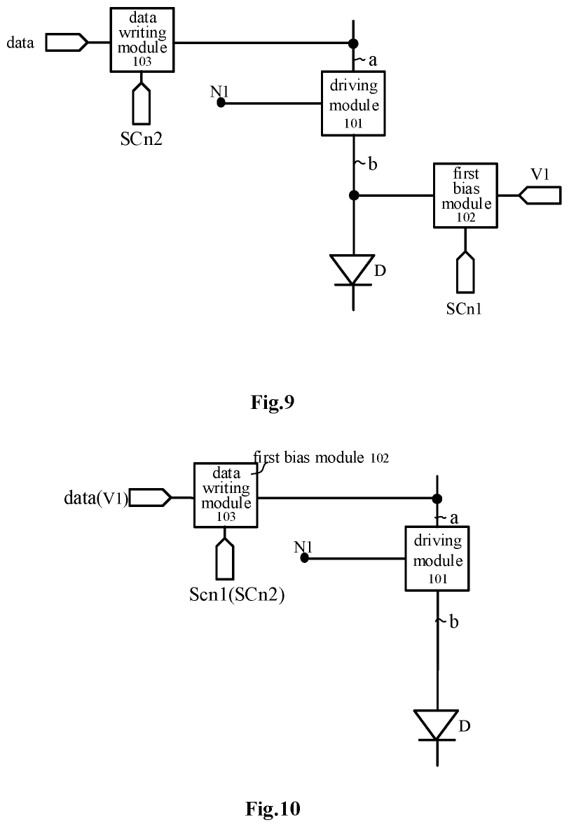

FIG. 9 is another circuit diagram of a pixel circuit provided by an embodiment of the present application. Combining FIGS. 8 and 9, according to some embodiments of the present application, optionally, the pixel circuit 10 may further include a data writing module 103. A control terminal of the data writing module 103 is electrically connected to a second scan signal terminal Scn2, a first terminal of the data writing module 103 is electrically connected to a data signal terminal data, and a second terminal of the data writing module 103 is electrically connected to the first terminal a or the second terminal b of the driving module 101. As described above, in some specific examples, under a condition that the driving module 101 is a thin film transistor, one of the first terminal a and the second terminal b of the driving module 101 may be a source of the thin film transistor, and the other one may be a drain of the thin film transistor. Similarly, the data writing module 103 may also be a transistor, the control terminal of the data writing module 103 may be a gate of the transistor, one of the first terminal and the second terminal of the data writing module 103 may be a source of the transistor, and the other one may be a drain of the transistor.

It should be noted that, similar to FIG. 2, FIG. 8 illustrates that the second terminal of the data writing module 103 is electrically connected to the first terminal a of the driving module 101. However, it is understood that the second terminal of the data writing module 103 may also be electrically connected to the second terminal b of the driving module 101.

In the data writing stage t81, the data writing module 103 may be turned on under a control of a second scan signal provided by the second scan signal terminal Scn2, and the data writing module 103 is configured to transmit the data signal provided by the data signal terminal data to the first terminal a or the second terminal b of the driving module 101. Specifically, in the data writing stage t81, the second scan signal terminal Scn2 may output the turn-on level (e.g., the low level), the data writing module 103 is turned on in response to the turn-on level output by the second scan signal terminal Scn2, and the data signal provided by the data signal terminal data is transmitted to the first terminal a or the second terminal b of the driving module 101 through the turned-on data writing module 103. For example, the second terminal b of the driving module 101 may be connected to the control terminal of the driving module 101, so that the data signal may be transmitted to the control terminal of the driving module 101 to achieve a control of the switching state of the driving module 101.

The inventor of the present application has found that, after the data signal is written to the driving module 101, the state of the driving module 101 is not too stable, and the threshold voltage Vth of the driving module will still change to a certain extent. Therefore, the threshold voltage Vth of the driving module will be unstable at the beginning of the light-emitting stage, resulting in the change of the light-emitting brightness at the beginning of the light-emitting stage.

In view of this, the present application considers to add a second bias stage between the data writing stage and the light-emitting stage, and to adjust the threshold voltage Vth of the driving module again. Therefore, the characteristic curve of the driving module 101 is restored to the normal threshold voltage corresponding to when the data signal is written as soon as possible, thereby avoiding the change of the light-emitting brightness at the beginning of the light-emitting stage.

Specifically, at least the bias stages p of the refresh frame F1 may also include a second bias stage p2, and the second bias stage p2 is located between the data writing stage t81 and the light-emitting stage f. It should be noted that, in some examples, only the refresh frame F1 includes the second bias stage p2. In other examples, the hold frame F2 may also include the second bias stage p2, which is not limited by the embodiments of the present application.

Combining FIGS. 8 and 9, in the second bias stage p2, the first bias module 102 is turned on, and the first bias signal is transmitted to the first terminal a or the second terminal b of the driving module 101, thereby further adjusting the threshold voltage Vth of the driving module by the first bias signal. Therefore, the characteristic curve of the driving module 101 is restored to the normal threshold voltage corresponding to when the data signal is written as soon as possible, thereby effectively avoiding the change of the light-emitting brightness at the beginning of the light-emitting stage.

FIG. 10 is another circuit diagram of a pixel circuit provided by an embodiment of the present application. As shown in FIG. 10, according to some embodiments of the present application, the first bias module 102 may be reused as the data writing module 103, the first scan signal terminal Scn1 may be reused as the second scan signal terminal Scn2, and the first bias signal terminal V1 may be reused as the data signal terminal data.

Specifically, in the first bias stage p1, the data writing module 103 is turned on in response to the turn-on level output by the second scan signal terminal Scn2, and the first bias signal provided by the data signal terminal data is transmitted to the first terminal a or the second terminal b of the driving module 101 through the turned-on data writing module 103. Thus, the driving module 101 is in the OBS state, thereby realizing the adjustment of the threshold voltage of the driving module 101. In the data writing stage t81, the data writing module 103 is turned on in response to the turn-on level output by the second scan signal terminal Scn2, and the data signal provided by the data signal terminal data is transmitted to the first terminal a or the second terminal b of the driving module 101 through the turned-on data writing module 103.

It should be noted that the voltage value of the first bias signal may be the same as or different from the voltage value of the data signal, which is not limited by the embodiments of this application.

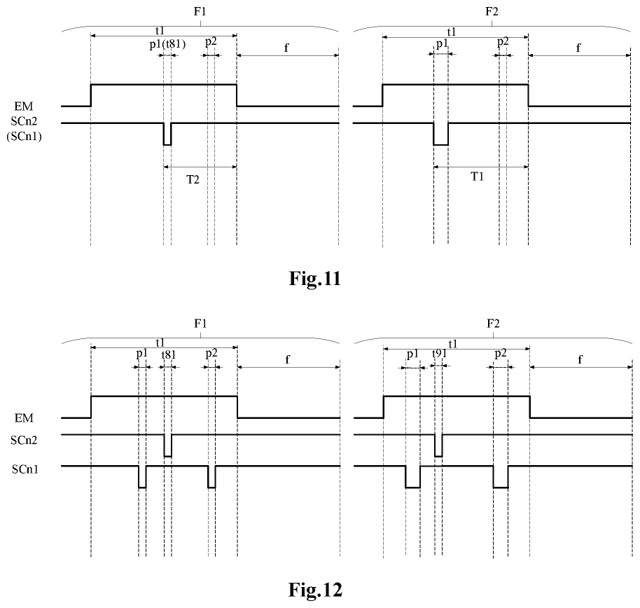

FIG. 11 is another time sequence diagram of a pixel circuit provided by an embodiment of the present application. As shown in FIG. 11, the turn-on duration of the data writing module 103 of the first bias stage p1 in the hold frame F2 may be greater than the turn-on duration of the data writing module 103 of the first bias stage p1 in the refresh frame F1. And/or, the time interval T1 between the turn-on start moment of the data writing module 103 in the hold frame F2 and the light-emitting stage in the hold frame F2 may be greater than the time interval T2 between the turn-on start moment of the data writing module 103 in the refresh frame F1 and the light-emitting stage in the refresh frame F1.

Thus, by increasing the turn-on duration of the data writing module 103 of the first bias stage p1 in the hold frame F2, and/or increasing the time interval T1 between the turn-on start moment of the data writing module 103 in the hold frame F2 and the light-emitting stage in the hold frame F2, the time period that the driving module is in the OBS state in the hold frame F2 may be increased. Therefore, the difference between the time period that the driving module is in the OBS state in the hold frame F2 and the time period that the driving module is in the OBS state in the refresh frame F1 may be improved. Further, the difference between the threshold voltage of the driving module in the hold frame F2 and the threshold voltage of the driving module in the refresh frame F1 may be improved, the difference between the brightness of the refresh frame F1 and the brightness of the hold frame F2 may be reduced, and the flashing problem may be improved.

FIG. 12 is another time sequence diagram of a pixel circuit provided by an embodiment of the present application. Combining FIGS. 9 and 12, according to some other embodiments of the present application, optionally, the first bias module 102 may also not be reused as the data writing module 103, that is, the pixel circuit 10 includes both the first bias module 102 and the data writing module 103. The hold frame F2 may also include a data writing module turn-on stage t91, wherein in hold frame F2, the data writing module turn-on stage t91 is located before the light-emitting stage f. In the data writing module turn-on stage t91, the second scan signal terminal Scn2 may output the turn-on level (e.g., a low level). The data writing module 103 is turned on in response to the turn-on level output by the second scan signal terminal Scn2, and the data signal provided by the data signal terminal data is transmitted to the first terminal a or the second terminal b of the driving module 101 through the turned-on data writing module 103. In the data writing module turn-on stage t91, the second terminal b of the driving module 101 is not connected to the control terminal of the driving module 101 (i.e., the terminal connected to the first node NT). Therefore, the data signal will not be transmitted to the control terminal of the driving module 101, and the potential of the control terminal of the driving module 101 will not be refreshed.

In the hold frame F2, the data writing module turn-on stage t91 may be located after the first bias stage p1, or the turn-on moment of the data writing module turn-on stage t91 is the same as the turn-on moment of the first bias stage p1. That is, in the first bias stage p1, it can be that only the first bias module 102 is turned on, and the driving module 101 is placed in the OBS state by the first bias signal, thereby realizing the adjustment of the threshold voltage Vth of the driving module 101. Further, in the first bias stage p1, it can be that both the first bias module 102 and the data writing module 103 are turned on, and the driving module 101 is placed in the OBS state by both the first bias signal and the data signal, thereby realizing the adjustment of the threshold voltage Vth of the driving module 101.

Continuing referring to FIG. 12, according to some embodiments of the present application, optionally, in the refresh frame F1, the data writing stage t81 may be located after the first bias stage p1.

Since both the first bias signal and the data signal are written to the first terminal or the second terminal of the driving module 101, the data writing stage t81 is provided after the first bias stage p1. Therefore, when writing the data signal, the data signal can be prevented from being interfered by the first bias signal, thereby ensuring that an accurate data signal is written to the driving module 101.

Further, either in the refresh frame F1 or in the hold frame F2, the turn-on pulses k in the first bias signal are located before the data writing module being turned on. In this way, the first bias signal can be kept at a stable frequency, and can be easily achieved by the driving IC.

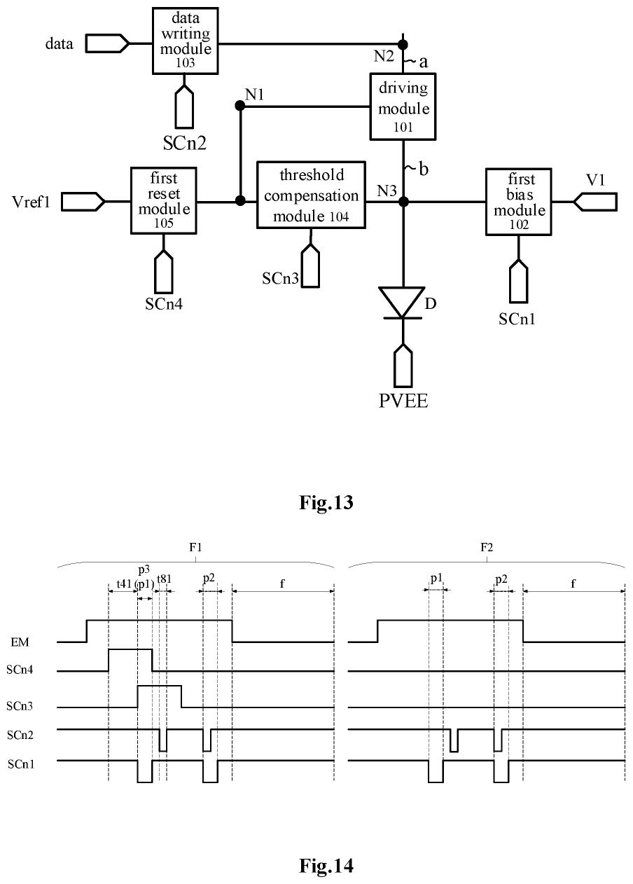

As shown in FIG. 12, a width of at least one of the pulses k in the hold frame F2 may be greater than a width of any one of the pulses k in the refresh frame F1, thereby increasing the time period that the driving module is in the OBS state in the hold frame F2, and improving the difference between the time period that the driving module is in the OBS state in the hold frame F2 and the time period that the driving module is in the OBS state in the refresh frame F1. However, the time period that the driving module is in the OBS state in the hold frame F2 may be increased by the above way of increasing the number of the pulses k in the hold frame F2 and/or increasing the first time interval T1′, which is not limited by the embodiments of the present application. FIG. 13 is another circuit diagram of a pixel circuit provided by an embodiment of the present application. As shown in FIG. 13, according to some embodiments of the present application, optionally, the control terminal of the driving module 101 is electrically connected to a first node N1, the first terminal a of the driving module 101 is electrically connected to a second node N2, and the second terminal b of the driving module 101 is electrically connected to a third node N3.

The pixel circuit 10 may also include a threshold compensation module 104, a control terminal of the threshold compensation module 104 is electrically connected to a third scan signal terminal Scn3, a first terminal of the threshold compensation module 104 is electrically connected to the first node N1, and a second terminal of the threshold compensation module 104 is electrically connected to the third node N3. The threshold compensation module 104 may be turned on under a control of a third scan signal provided by the third scan signal terminal Scn3, and the threshold compensation module 104 may be configured to connect the control terminal of the driving module 101 and the second terminal of the driving module 101. For example, in the data writing stage, the threshold compensation module 104 may be turned on to connect the control terminal of the driving module 101 with the second terminal of the driving module 101, thereby compensating for the threshold voltage of the driving module 101 together with the data writing module 103.

The pixel circuit 10 may also include a first reset module 105, a control terminal of the first reset module 105 is electrically connected to a fourth scan signal terminal Scn4, a first terminal of the first reset module 105 is electrically connected to a first initialization signal terminal Vref1, and a second terminal of the first reset module 105 is electrically connected to the first node N1. The first reset module 105 may be turned on under a control of a fourth scan signal provided by the fourth scan signal terminal Scn4, and may transmit a first initialization signal provided by the first initialization signal terminal Vref1 to the first node N1, so as to reset the first node N1.

In the embodiments of the present application, in addition to increasing the turn-on duration of the first bias module in the hold frame and/or increasing the time interval between the turn-on start moment of the first bias module in the hold frame and the light-emitting stage in the hold frame, the time period that the driving module is in the on-bias state in the refresh frame may be reduced by at least partially overlapping the turn-on stage of the first bias module in the refresh frame with other bias stages in the refresh frame. Therefore, the difference between the threshold voltage of the driving module in the hold frame and the threshold voltage of the driving module in the refresh frame may be improved, and the flashing problem may be improved. The details are shown in FIG. 14.

FIG. 14 is another time sequence diagram of a pixel circuit provided by an embodiment of the present application. Combining FIGS. 13 and 14, the bias stages p of the refresh frame F1 may also include a third bias stage p3, and the third bias stage p3 may at least partially overlap with the first bias stage p1. In the third bias stage p3, the threshold compensation module 104 is turned on under a control of the third scan signal provided by the third scan signal terminal Scn3, the first reset module 105 is turned on under a control of a fourth scan signal provided by the fourth scan signal terminal Scn4, and a second bias signal output by the first initialization signal terminal Vref1 is transmitted to the control terminal of the driving module 101 and the second terminal of the driving module 101. Similar to the first bias signal, the second bias signal may be configured to adjust the bias state of the driving module 101. That is, the driving module 101 may be in the OBS state, thereby achieving the adjustment of the threshold voltage Vth of the driving module 101.

Meanwhile, the third bias stage p3 at least partially overlaps with the first bias stage p1. Therefore, in a partial stage of the first bias stage p1 overlapping with the third bias stage p3, the first bias module 102 is also turned on, and the first bias signal is transmitted to the first terminal or the second terminal of the driving module 101.

Thus, in the third bias stage p3, since the threshold compensation module 104 is turned on to connect the control terminal of the driving module 101 and the second terminal of the driving module 101, the potential of the second terminal of the driving module 101 may be equal to the potential of the control terminal of the driving module 101. Under a control of both the first bias signal and the second bias signal, the driving module 101 is in the OBS state, thereby achieving the adjustment of the threshold voltage Vth of the driving module 101. For different pixel circuits, the voltage value of the second bias signal can vary. Therefore, the second bias signal of a corresponding voltage value can be matched according to the bias degree of the threshold voltage of the driving module 101, thereby achieving a precise adjustment of the threshold voltage of the driving module 101.

In the embodiments of the present application, by adding the first bias stage p1 in the hold frame F2, the time period that the driving module is in the OBS state in the hold frame may be increased. Therefore, the difference between the time period that the driving module is in the OBS state in the hold frame and the time period that the driving module is in the OBS state in the refresh frame may be improved, and the flashing problem may be improved. However, the inventor of the present application considers that if only adding the first bias frame stage p1 in the hold frame F2, it will inevitably cause the difference between the Scn1 signal in the refresh frame F1 and the Scn1 signal in the hold frame F2, which increases the complexity of the Scn1 signal, and is not convenient for the output adjustment of the driving IC. Therefore, on the basis of adding the first bias stage p1 in the hold frame F2, the first bias stage p1 is also added in the refresh frame F1. Therefore, the Scn1 signal maintains a stable frequency in the refresh frame F1 and the hold frame F2, which reduces the complexity of the Scn1 signal, and facilitates the implementation of the drive IC. Further, by overlapping the first bias stage p1 with the third bias stage p3 in the refresh frame F1, the third bias stage p3 covers the first bias stage p1. Therefore, even if the first bias stage p1 is added in the refresh frame F1, since the first bias stage p1 overlaps with the third bias stage p3, the time period that the driving module is in the OBS state in the refresh frame F1 is not additionally increased. That is, the time period that the driving module is in the OBS state in the refresh frame is reduced, which is beneficial to reduce the difference between the time period that the driving module is in the OBS state in the hold frame and the time period that the driving module is in the OBS state in the refresh frame. Moreover, in a stage that the first bias stage p1 overlaps with the third bias stage p3, the first bias module 102, the threshold compensation module 104 and the first reset module 105 are all turned on. Under a control of both the first bias signal and the second bias signal, the adjustment of the threshold voltage Vth of the driving module 101 is achieved, and a good adjustment effect is achieved.

Further, the OBS time difference between the hold frame F2 and the refresh frame F1 is that the refresh frame F1 has the third bias stage p3 and the hold frame F2 do not have the third bias stage p3. With such a design, it can be ensured that the time position of the first bias stage p1 in the hold frame F2 is consistent with the time position of the third bias stage p3 in the refresh frame F1 (i.e., the overlapped stage of the turn-on level of the Scn3 and the turn-on level of the Scn4), and the OBS time difference between the hold frame F2 and the refresh frame F1 is reduced.

Optionally, the turn-on stage of the first bias module 102 in the hold frame F2 at least partially not overlaps with other bias stages in the hold frame F2.

Of course, in other alternative embodiments of the present application, the turn-on stage of the first bias module 102 in the hold frame F2 at least partially overlaps with the other bias stages in the hold frame F2. However, that overlapped duration is less than the duration during which the turn-on stage of the first bias module 102 in the refresh frame F1 overlaps with the other bias stages in the refresh frame F1. That is, the duration during which the effective bias signal of the first bias module 102 independently affects the driving module in the hold frame F2 is greater than that in the refresh frame F1.

Optionally, the bias signal of the other bias stages is also applied to the node where the first bias module is connected to the pixel circuit. Alternatively, other modules in the circuit to which the other bias stages are directed at least partially consistent with the module to which the first bias module is directed.

Combining FIGS. 13 and 14, according to some embodiments of the present application, optionally, the first stage t1 of the refresh frame F1 may also include an initialization stage t41, and the initialization stage t41 may be located before the data writing stage t81. In the initialization stage t41, the threshold compensation module 104 is turned off under a control of the third scan signal provided by the third scan signal terminal Scn3. The first reset module 105 is turned on under a control of the fourth scan signal provided by the fourth scan signal terminal Scn4. The first initialization signal output by the first initialization signal terminal Vref1 is transmitted to the control terminal (i.e., the first node NT) of the driving module 101, thereby achieving reset of the first node NT. Here, the voltage value of the first initialization signal may be the same as or different from the voltage value of the second bias signal, which is not limited by the embodiments of the present application.

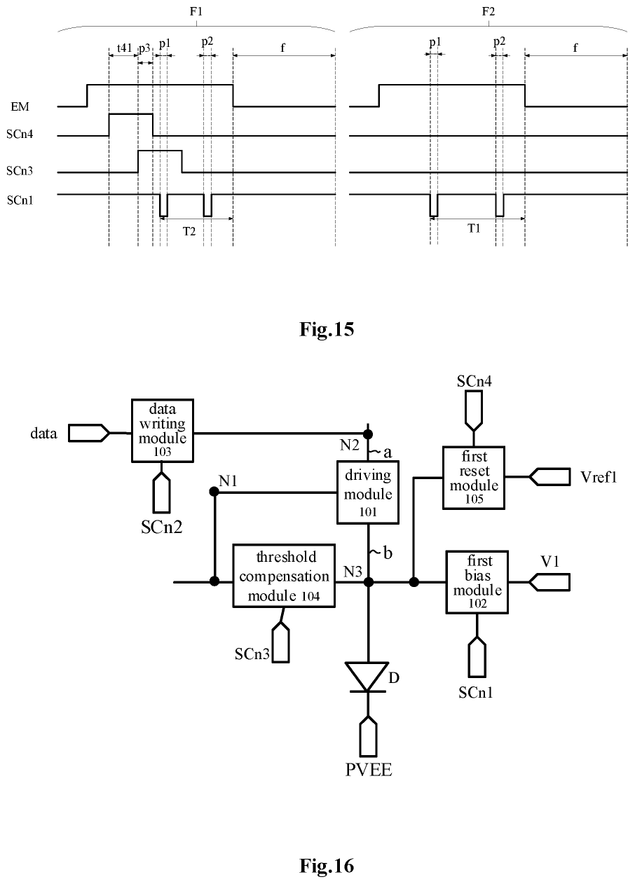

FIG. 15 is another time sequence diagram of a pixel circuit provided by an embodiment of the present application. Combining FIGS. 13 and 15, unlike the embodiment shown in FIG. 14, the third bias stage p3 may be located before the first bias stage p1.

In the third bias stage p3, the threshold compensation module 104 is turned on under a control of the third scan signal provided by the third scan signal terminal Scn3. The first reset module 105 is turned on under a control of the fourth scan signal provided by the fourth scan signal terminal Scn4. The second bias signal output by the first initialization signal terminal Vref1 is transmitted to the control terminal of the driving module 101 and the second terminal of the driving module 101. Similar to the first bias signal, the second bias signal may be configured to adjust the bias state of the driving module 101. That is, the driving module 101 may be in the OBS state, thereby achieving the adjustment of the threshold voltage Vth of the driving module 101.

Thus, under a control of the second bias signal, the driving module 101 is in the OBS state, thereby achieving the adjustment of the threshold voltage Vth of the driving module 101. For different pixel circuits, the voltage value of the second bias signal can vary. Therefore, the second bias signal of a corresponding voltage value can be matched according to the bias degree of the threshold voltage of the driving module 101, thereby achieving a precise adjustment of the threshold voltage of the driving module 101.

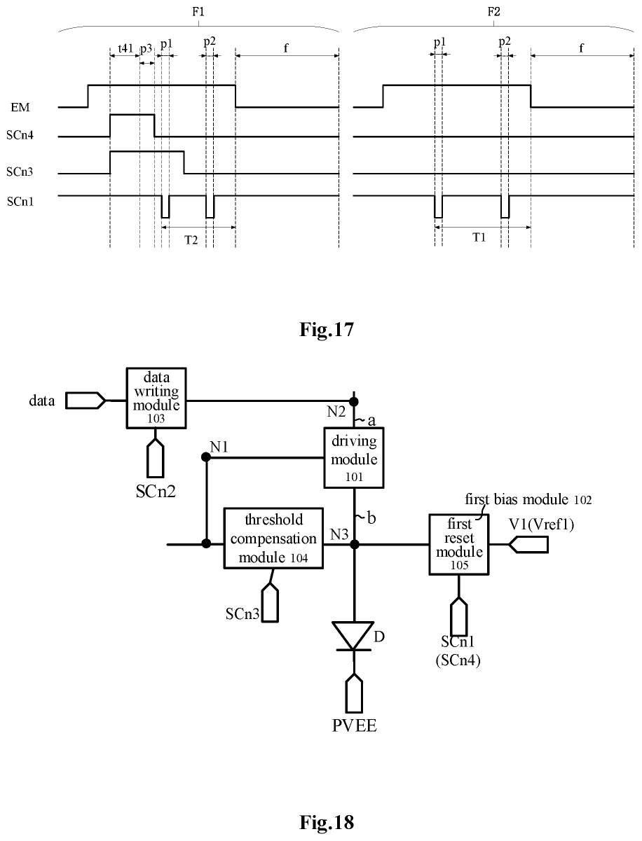

As shown in FIG. 15, the time interval T1 between the turn-on start moment of the first bias module in the hold frame F2 and the light-emitting stage in the hold frame F2 may be greater than the time interval T2 between the turn-on start moment of the first bias module in the refresh frame F1 and the light-emitting stage in the refresh frame F1. Therefore, the time period that the driving module is in the OBS state in the hold frame F2 may be increased, and the difference between the time period that the driving module is in the OBS state in the hold frame F2 and the time period that the driving module is in the OBS state in the refresh frame F1 may be improved. However, the time period that the driving module is in the OBS state in the hold frame F2 may be increased by the above ways of increasing the number and/or the width of the pulses k in the hold frame F2, which is not limited by the embodiments of the present application. Similarly, in FIGS. 17, 19, 21, 24, 29, and 31 shown below, the time interval T1 is greater than the time interval T2. For the sake of simplicity, it will not be repeated below.

FIG. 16 is another circuit diagram of a pixel circuit provided by an embodiment of the present application. As shown in FIG. 16, unlike the embodiment shown in FIG. 13, according to some other embodiments of the present application, the second terminal of the first reset module 105 may be electrically connected to the third node N3.

Specifically, the control terminal of the threshold compensation module 104 is electrically connected to the third scan signal terminal Scn3, the first terminal of the threshold compensation module 104 is electrically connected to the first node N1, and the second terminal of the threshold compensation module 104 is electrically connected to the third node N3. The threshold compensation module 104 may be turned on under a control of the third scan signal provided by the third scan signal terminal Scn3, and the threshold compensation module 104 may be configured to connect the control terminal of the driving module 101 and the second terminal of the driving module 101. The control terminal of the first reset module 105 is electrically connected to the fourth scan signal terminal Scn4, the first terminal of the first reset module 105 is electrically connected to the first initialization signal terminal Vref1, and the second terminal of the first reset module 105 is electrically connected to the third node N3.

FIG. 17 is another time sequence diagram of a pixel circuit provided by an embodiment of the present application. Combining FIGS. 16 and 17, according to some embodiments of the present application, optionally, the first stage t1 of the refresh frame F1 may also include an initialization stage t41, and the initialization stage t41 may be located before the data writing stage t81. For example, the threshold compensation module 104 may be turned on under a condition that the third scan signal terminal Scn3 outputs a high level, and the first reset module 105 may be turned on under a condition that the fourth scan signal terminal Scn4 outputs a low level. In the initialization stage t41, the threshold compensation module 104 is turned on under a control of the third scan signal provided by the third scan signal terminal Scn3, and the first reset module 105 is turned on under a control of the fourth scan signal provided by the fourth scan signal terminal Scn4. The first initialization signal output by the first initialization signal terminal Vref1 is transmitted to the control terminal (i.e., the first node N1) of the driving module 101 through the turned-on first reset module 105 and the turn-on threshold compensation module 104 in sequence, thereby achieving reset of the first node N1. Here, the voltage value of the first initialization signal may be the same as or different from the voltage value of the second bias signal, which is not limited by the embodiments of the present application.

In the third bias stage p3, the threshold compensation module 104 is turned on under a control of the third scan signal provided by the third scan signal terminal Scn3. The first reset module 105 is turned on under a control of the fourth scan signal provided by the fourth scan signal terminal Scn4. The second bias signal output by the first initialization signal terminal Vref1 is transmitted to the control terminal of the driving module 101 and the second terminal of the driving module 101. Therefore, the driving module 101 may be in the OBS state, thereby achieving the adjustment of the threshold voltage Vth of the driving module 101.

It should be noted that, in some embodiments, in the refresh frame F1, the initialization stage t41 and the third bias stage p3 can overlap with each other, that is, the initialization stage t41 and the third bias stage p3 can be regarded as a same stage. Therefore, while the reset of the first node N1 is achieved, the driving module 101 is in the OBS state, thereby achieving the adjustment of the threshold voltage Vth of the driving module 101.

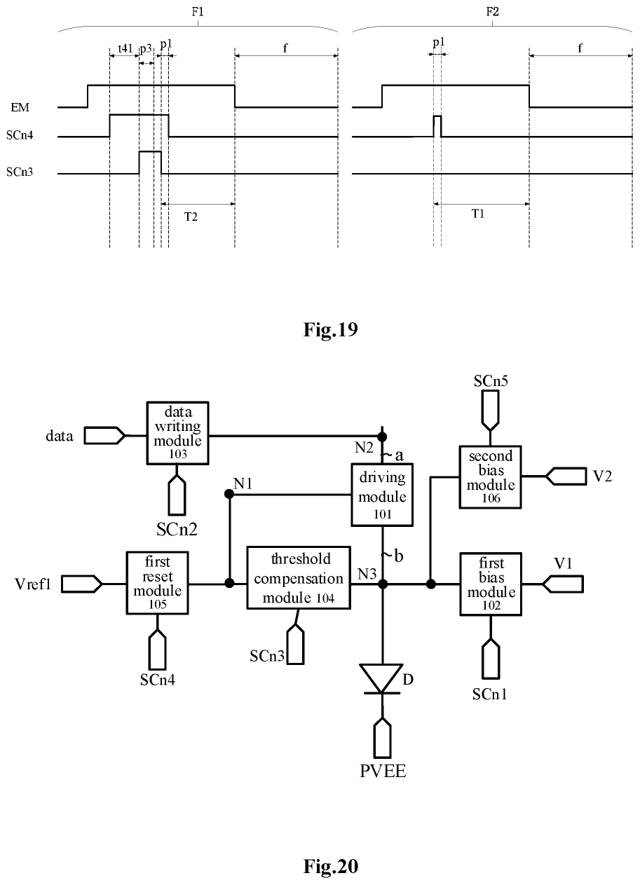

FIG. 18 is another circuit diagram of a pixel circuit provided by an embodiment of the present application. As shown in FIG. 18, according to some embodiments of the present application, optionally, the first bias module 102 may be reused as the first reset module 105. The control terminal of the first reset module 105 is electrically connected to the fourth scan signal terminal Scn4, the first terminal of the first reset module 105 is electrically connected to the first initialization signal terminal Vref1, and the second terminal of the first reset module 105 is electrically connected to the third node N3. FIG. 19 is another time sequence diagram of a pixel circuit provided by an embodiment of the present application. Combining FIGS. 18 and 19, in the first bias stage p1, the first reset module 105 is turned on, and the first bias signal output by the first initialization signal terminal Vref1 is transmitted to the second terminal of the driving module 101.

Specifically, for example, the first reset module 105 is turned on under a condition that the fourth scan signal terminal Scn4 outputs a low level. In the first bias stage p1, the first reset module 105 is turned on under a control of the fourth scan signal provided by the fourth scan signal terminal Scn4, and the first bias signal output by the first initialization signal terminal Vref1 is transmitted to the control terminal of the driving module 101 and the second terminal of the driving module 101. Therefore, the driving module 101 is in the OBS state, thereby achieving the adjustment of the threshold voltage Vth of the driving module 101.

For example, the threshold compensation module 104 may be turned on under a condition that the third scan signal terminal Scn3 outputs a high level, and the first reset module 105 may be turned on under a condition that the fourth scan signal terminal Scn4 outputs a low level. In the initialization stage t41 of the refresh frame F1, the threshold compensation module 104 is turned on under a control of the third scan signal provided by the third scan signal terminal Scn3, and the first reset module 105 is turned on under a control of the fourth scan signal provided by the fourth scan signal terminal Scn4. The first initialization signal output by the first initialization signal terminal Vref1 is transmitted to the control terminal (i.e., the first node N1) of the driving module 101 through the turned-on first reset module 105 and the turn-on threshold compensation module 104 in sequence, thereby achieving reset of the first node N1. Here, the voltage value of the first initialization signal may be the same as or different from the voltage value of the first bias signal, which is not limited by the embodiments of the present application.

Thus, since the first bias module 102 is reused as the first reset module 105, the number of electronic devices in the pixel circuit can be reduced, which is beneficial to save the wiring space and reduce the production cost.

FIG. 20 is another circuit diagram of a pixel circuit provided by an embodiment of the present application. As shown in FIG. 20, according to some embodiments of the present application, optionally, the pixel circuit 10 may also include a second bias module 106. A control terminal of the second bias module 106 may be electrically connected to a fifth scan signal terminal Scn5, a first terminal of the second bias module 106 is electrically connected to the second bias signal terminal V2, and a second terminal of the second bias module 106 is electrically connected to the first terminal or the second terminal of the driving module 101.

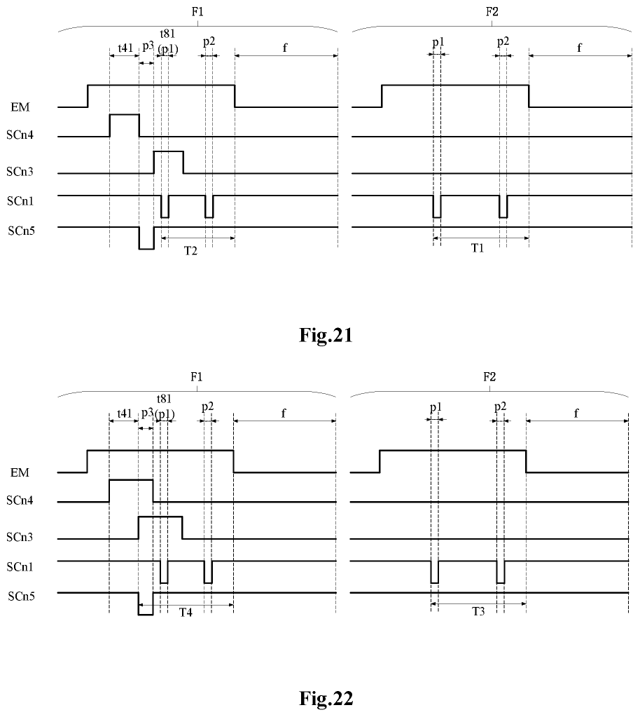

FIG. 21 is another time sequence diagram of a pixel circuit provided by an embodiment of the present application. Combining FIGS. 20 and 21, in the refresh frame F1, the data writing stage t81 may overlap with the first bias stage p1, and the third bias stage p3 may be located before the first bias stage p1. In the third bias stage p3, the second bias module 106 is turned on under a control of a fifth scan signal provided by the fifth scan signal terminal Scn5, and a second bias signal output by the second bias signal terminal V2 is transmitted to the first terminal or the second terminal of the driving module 101. Therefore, the driving module 101 is in the OBS state, thereby achieving the adjustment of the threshold voltage Vth of the driving module 101.

Thus, before the data writing stage t81, the threshold voltage Vth of the driving module 101 is adjusted by the second bias signal. Therefore, the shift degree of the Id-Vg curve of the driving module is reduced. Further, the display uniformity of the display panel is guaranteed, and the brightness of the first frame when switching pictures is increased.

Further, combining FIGS. 20 and 21, according to some embodiments of the present application, optionally, the time interval T3 between the turn-on start moment of the first bias module 102 in the hold frame F2 and the light-emitting stage f in the hold frame F2 may be equal to the time interval T4 between the turn-on start moment of the second bias module 106 in the refresh frame F1 and the light-emitting stage f in the refresh frame F1.

Thus, since the time interval T3 is equal to the time interval T4, the time period that the driving module is in the OBS state in the hold frame F2 is equal to the time period that the driving module is in the OBS state in the refresh frame F1. Therefore, there is almost no difference between the threshold voltage of the driving module in the hold frame F2 and the threshold voltage of the driving module in the refresh frame F1. Thus, the difference between the brightness of the refresh frame F1 and the brightness of the hold frame F2 may be small, and the flashing problem may be improved

FIG. 22 is another time sequence diagram of a pixel circuit provided by an embodiment of the present application. Combining FIGS. 20 and 22, according to another embodiment of the present application, optionally, in the third bias stage p3, the threshold compensation module 104 and the first reset module 105 may also be turned on. Specifically, in the third bias stage p3, the threshold compensation module 104 is turned on under a control of the third scan signal provided by the third scan signal terminal Scn3. The first reset module 105 is turned on under a control of the fourth scan signal provided by the fourth scan signal terminal Scn4. The second bias module 106 is turned on under a control of a fifth scan signal provided by the fifth scan signal terminal Scn5. The second bias signal output by the first initialization signal terminal Vref1 is transmitted to the control terminal of the driving module 101 and the second terminal of the driving module 101. The third bias signal output by the second bias signal terminal V2 is transmitted to the first terminal or the second terminal of the driving module 101. Similar to the first bias signal and the second bias signal, the third bias signal may be configured to adjust the bias state of the driving module 101. That is, the driving module 101 may be in the OBS state, thereby achieving the adjustment of the threshold voltage Vth of the driving module 101.

Thus, under a control of both the second bias signal and the third bias signal, the driving module 101 is in the OBS state, thereby achieving the adjustment of the threshold voltage Vth of the driving module 101.

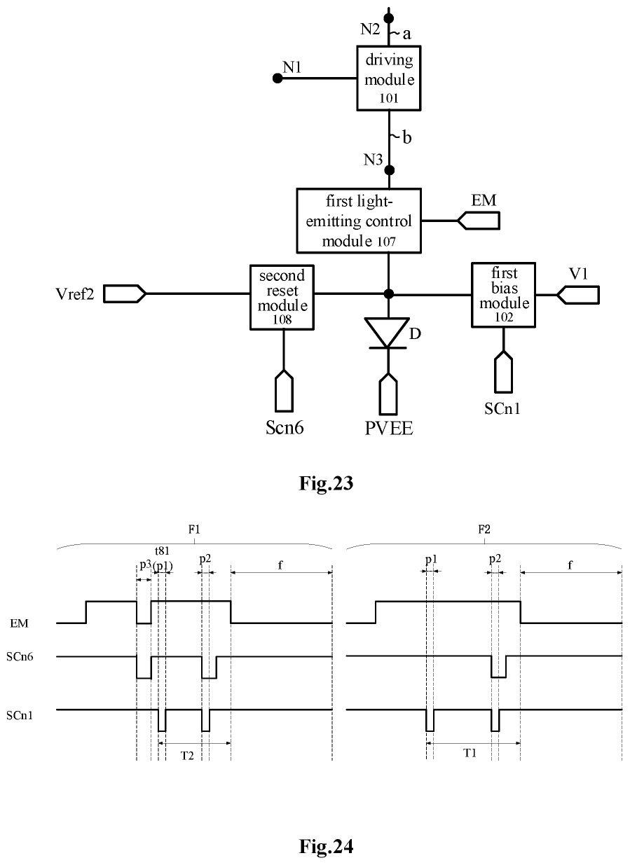

FIG. 23 is another circuit diagram of a pixel circuit provided by an embodiment of the present application. As shown in FIG. 23, according to some embodiments of the present application, optionally, the pixel circuit 10 may also include a first light-emitting control module 107. A control terminal of the first light-emitting control module 107 is electrically connected to a light-emitting control signal line EM, a first terminal of the first light-emitting control module 107 is electrically connected to the second terminal of the driving module 101, and a second terminal of the first light-emitting control module 107 is electrically connected to the first electrode of the light-emitting element D. Here, the light-emitting element D may include a first electrode and a second electrode, the first electrode of the light-emitting element D may be an anode of the light-emitting element D, and the second electrode of the light-emitting element D may be a cathode of the light-emitting element D.

The pixel circuit 10 may further includes a second reset module 108, a control terminal of the second reset module 108 is electrically connected to a sixth scan signal terminal Scn6, a first terminal of the second reset module 108 is electrically connected to a second initialization signal terminal Vref2, and a second terminal of the second reset module 108 is electrically connected to the first electrode of the light-emitting element D.

FIG. 24 is another time sequence diagram of a pixel circuit provided by an embodiment of the present application. Combining FIGS. 23 and 24, in the refresh frame F1, the data writing stage t81 may overlap with the first bias stage p1, and the third bias stage p3 may be located before the first bias stage p1. In the third bias stage p3, the first light-emitting control module 107 is turned on under a control of a light-emitting control signal provided by the light-emitting control signal terminal EM, the second reset module 108 is turned on under a control of a sixth scan signal provided by the sixth scan signal terminal Scn6, and a second bias signal output by the second initialization signal terminal Vref2 is transmitted to the second terminal of the driving module 101. Therefore, the driving module 101 is in the OBS state, thereby achieving the adjustment of the threshold voltage Vth of the driving module 101.

The second reset module 108 can also be turned on under a control of the sixth scan signal provided by the sixth scan signal terminal Scn6 in any stage (for example, the data writing stage) prior to the light-emitting stage f. Further, the second initialization signal output by the second initialization signal terminal Vref2 is transmitted to the first electrode of the light-emitting element D, thereby resetting the first electrode of the light-emitting element D. Here, the voltage value of the second initialization signal may be the same as or different from the voltage value of the second bias signal.

Thus, by reusing the second reset module 108 to adjust the threshold voltage Vth of the driving module 101, the number of electronic devices in the pixel circuit can be reduced, which is beneficial to save the wiring space and reduce the production cost.

In the embodiments of the present application, the pixel circuit may be applied in a display panel, and a picture refresh cycle H of the display panel may include a plurality of frames. For example, when the display panel displays at a low refresh rate, a picture refresh cycle H may include one refresh frame F1 and at least two hold frames F2. Here, the number of the hold frames F2 in a picture refresh cycle H can be flexibly adjusted according to the actual situation, which is not limited by the embodiments of the present application.

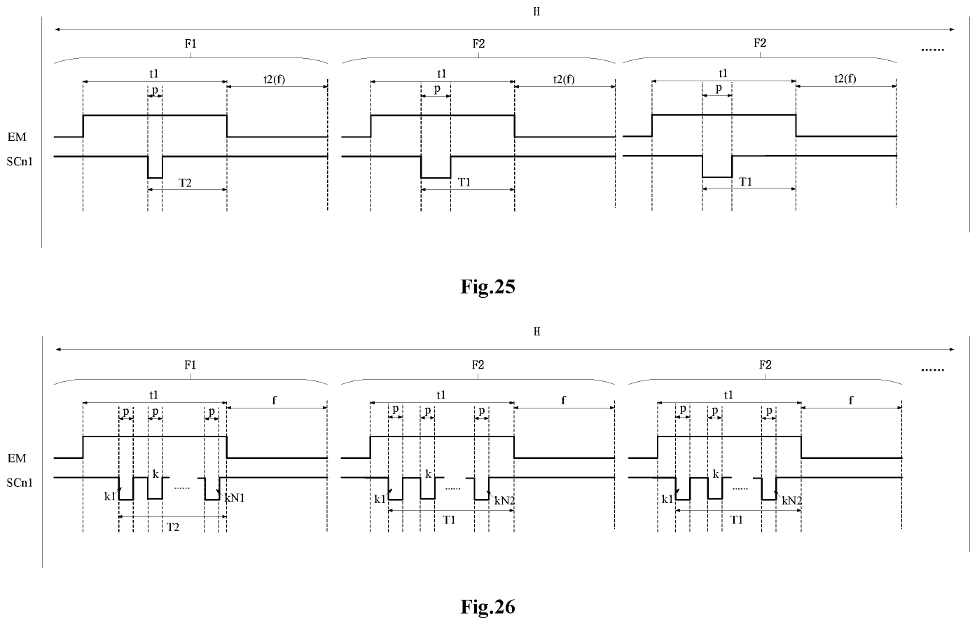

FIG. 25 is another time sequence diagram of a pixel circuit provided by an embodiment of the present application. As shown in FIG. 25, according to some embodiments of the present application, optionally, for example, the first bias module 102 is turned on at a low level. In a same picture refresh cycle H, the turn-on duration of the first bias module in the i^{th} hold frame F2 may be equal to the turn-on duration of the first bias module in the (i+1)^{th} hold frame F2, where i is a positive integer. And/or, in a same picture refresh cycle H, the time interval between the turn-on start moment of the first bias module in the i^{th} hold frame F2 and the light-emitting stage in the i^{th} hold frame F2 may be equal to the time interval between the turn-on start moment of the first bias module in the (i+1)^{th} hold frame F2 and the light-emitting stage in the (i+1)^{th} hold frame F2.

Thus, the time period that the driving module is in the OBS state may be the same or similar among the plurality of hold frames F2 in the same picture refresh cycle. Therefore, the threshold voltage of the driving module may be the same or similar among the plurality of hold frames F2 in the same picture refresh cycle. Further, the brightness of the plurality of hold frames F2 in the same picture refresh cycle may be the same or similar, so that the brightness-flashing problem between different hold frames F2 may be further improved.

FIG. 26 is another time sequence diagram of a pixel circuit provided by an embodiment of the present application. As shown in FIG. 26, in some specific embodiments, the turn-on duration of the first bias module in the i^{th} hold frame F2 being equal to the turn-on duration of the first bias module in the (i+1)^{th} hold frame F2 may specifically include:

a number of pulses of the first scan signal in the i^{th} hold frame F2 is equal to a number of pulses of the first scan signal in the (i+1)^{th} hold frame F2. Specifically, the number of pulses k of the first scan signal in the i^{th} hold frame F2 may be greater than the number of pulses k of the first scan signal in the refresh frame F1, the number of pulses k of the first scan signal in the (i+1)^{th} hold frame F2 may be greater than the number of pulses k of the first scan signal in the refresh frame F1, and the number of pulses k of the first scan signal in the i^{th} hold frame F2 may be equal to the number of pulses k of the first scan signal in the (i+1)^{th} hold frame F2.

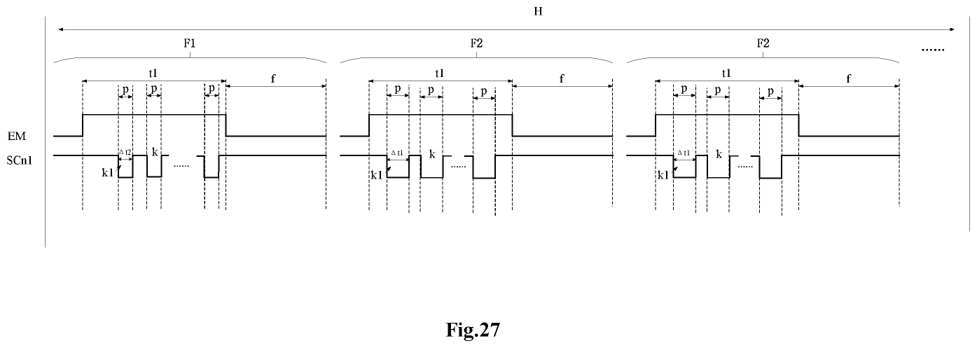

FIG. 27 is another time sequence diagram of a pixel circuit provided by an embodiment of the present application. As shown in FIG. 27, in some specific embodiments, the turn-on duration of the first bias module in the i^{th} hold frame F2 being equal to the turn-on duration of the first bias module in the (i+1)^{th} hold frame F2 may specifically include:

a width of the pulse of the first scan signal in the i^{th} hold frame F2 is equal to a width of the pulse of the first scan signal in the (i+1)^{th} hold frame F2. For example, the width of each pulse k in the i^{th} hold frame F2 and the (i+1)^{th} hold frame F2 is Δt1, and the width of each pulse k in the refresh frame F1 is Δt2, where Δt1>Δt2.

Thus, the turn-on duration of the first bias module in the hold frame F2 is greater than the turn-on duration of the first bias module in the refresh frame F1. Therefore, the difference between the time period that the driving module is in the OBS state in the hold frame F2 and the time period that the driving module is in the OBS state in the refresh frame F1 may be improved. Further, the difference between the threshold voltage of the driving module in the hold frame F2 and the threshold voltage of the driving module in the refresh frame F1 may be improved, the difference between the brightness of the refresh frame F1 and the brightness of the hold frame F2 may be reduced, and the flashing problem may be improved. Meanwhile, the time period that the driving module is in the OBS state may be the same or similar among the plurality of hold frames F2 in the same picture refresh cycle. Therefore, the threshold voltage of the driving module may be the same or similar among the plurality of hold frames F2 in the same picture refresh cycle. Further, the brightness of the plurality of hold frames F2 in the same picture refresh cycle may be the same or similar, so that the brightness-flashing problem between different hold frames F2 may be further improved.

For convenience, the pixel circuit of the embodiments of the present application will be illustrated below in combination with some specific application embodiments.

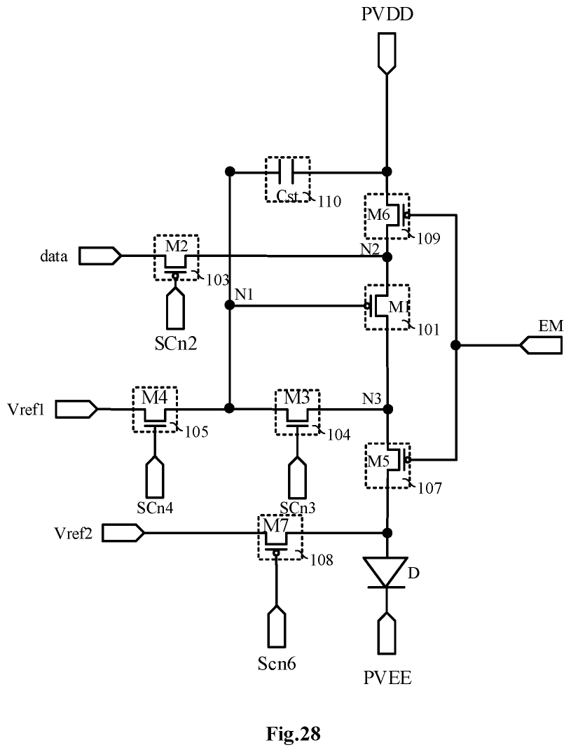

FIG. 28 is another circuit diagram of a pixel circuit provided by an embodiment of the present application. As shown in FIG. 28, in some specific embodiments, optionally, the pixel circuit 10 may be a 7T1C pixel circuit, that is, a pixel circuit including seven transistors and a storage capacitor. The data writing module can be reused as the first bias module. Specifically, the pixel circuit 10 may include a driving module 101, a data writing module 103, a threshold compensation module 104, a first reset module 105, a first light-emitting control module 107, a second reset module 108, a second light-emitting control module 109, and a storage module 110.

The control terminal of the driving module 101 may be electrically connected to a first node N1, the first terminal of the driving module 101 may be electrically connected to a second node N2, and the second terminal of the driving module 101 may be electrically connected to a third node N3.

The control terminal of the data writing module 103 is electrically connected to the second scan signal terminal Scn2, the first terminal of the data writing module 103 is electrically connected to the data signal terminal data, and the second terminal of the data writing module 103 is electrically connected to the first terminal or the second terminal of the driving module 101.

The control terminal of the threshold compensation module 104 is electrically connected to the third scan signal terminal Scn3, the first terminal of the threshold compensation module 104 is electrically connected to the first node N1, and the second terminal of the threshold compensation module 104 is electrically connected to the third node N3.

The control terminal of the first reset module 105 is electrically connected to the fourth scan signal terminal Scn4, the first terminal of the first reset module 105 is electrically connected to the first initialization signal terminal Vref1, and the second terminal of the first reset module 105 is electrically connected to the first node N1.

The control terminal of the first light-emitting control module 107 is electrically connected to the light-emitting control signal line EM, the first terminal of the first light-emitting control module 107 is electrically connected to the second terminal of the driving module 101, and the second terminal of the first light-emitting control module 107 is electrically connected to the first electrode of the light-emitting element D.

The control terminal of the second reset module 108 is electrically connected to the sixth scan signal terminal Scn6, the first terminal of the second reset module 108 is electrically connected to the second initialization signal terminal Vref2, and the second terminal of the second reset module 108 is electrically connected to the first electrode of the light-emitting element D.

The control terminal of the second light-emitting control module 109 is electrically connected to the light-emitting control signal line EM, the first terminal of the second light-emitting control module 109 is electrically connected to the first power signal terminal PVDD, and the second terminal of the second light-emitting control module 109 is electrically connected to the second node N2.

The first terminal of the storage module 110 is electrically connected to the first power signal terminal PVDD, and the second terminal of the storage module 110 is electrically connected to the first node N1.

In some embodiments, the second scan signal terminal Scn2 may be reused as the sixth scan signal terminal Scn6.

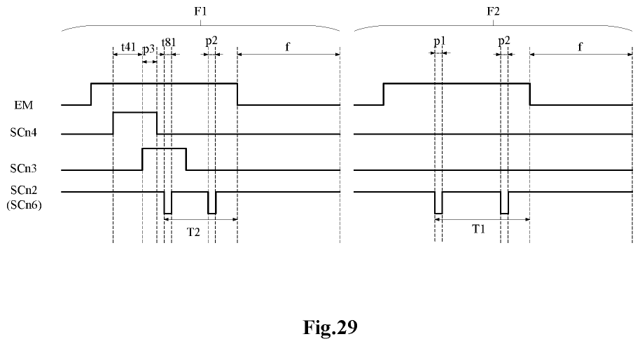

FIG. 29 is another time sequence diagram of a pixel circuit provided by an embodiment of the present application. Combining FIGS. 28 and 29, the refresh frame F1 may include an initialization stage t41, a third bias stage p3, a data writing stage t81, a second bias stage p2, and a light-emitting stage f arranged in time sequence. Here, the data writing stage t81 in the refresh frame F1 may be the same stage as the first bias stage p1 in the refresh frame F1. The hold frame F2 may include a first bias stage p1, a second bias stage p2, and a light-emitting stage f arranged in time sequence.

In the initialization stage t41 of the refresh frame F1, the threshold compensation module 104 is turned off under a control of the third scan signal provided by the third scan signal terminal Scn3. The first reset module 105 is turned on under a control of the fourth scan signal provided by the fourth scan signal terminal Scn4. The first initialization signal output by the first initialization signal terminal Vref1 is transmitted to the control terminal (i.e., the first node N1) of the driving module 101, thereby achieving reset of the first node N1.

In the third bias stage p3 of the refresh frame F1, the threshold compensation module 104 is turned on under a control of the third scan signal provided by the third scan signal terminal Scn3. The first reset module 105 is turned on under a control of the fourth scan signal provided by the fourth scan signal terminal Scn4. The second bias signal output by the first initialization signal terminal Vref1 is transmitted to the control terminal of the driving module 101 and the second terminal of the driving module 101. Therefore, the driving module 101 may be in the OBS state, thereby achieving the adjustment of the threshold voltage Vth of the driving module 101.

In the data writing stage t81 of the refresh frame F1, the data writing module 103 is turned on in response to the turn-on level output by the second scan signal terminal Scn2, and the data signal provided by the data signal terminal data is transmitted to the first terminal of the driving module 101 through the turned-on data writing module 103. Under a control of the third scan signal provided by the third scan signal terminal Scn3, the threshold compensation module 104 is turned on to connect the control terminal of the driving module 101 with the second terminal of the driving module 101, thereby compensating for the threshold voltage of the driving module 101 together with the data writing module 103.

In the second bias stage p2 of the refresh frame F1, the data writing module 103 is turned on in response to the turn-on level output by the second scan signal terminal Scn2. The threshold compensation module 104 is turned off under a control of the third scan signal provided by the third scan signal terminal Scn3. The first bias signal provided by the data signal terminal data is transmitted to the first terminal of the driving module 101 through the turned-on data writing module 103. Since the first node N1 is at a low level, the driving module 101 is turned on, and the first bias signal provided by the data signal terminal data is transmitted to the second terminal of the driving module 101 through the turned-on driving module 101. Therefore, the potential of the second terminal of the driving module 101 is greater than or equal to the potential of the control terminal of the driving module 101, thereby further adjusting the threshold voltage Vth of the driving module by the first bias signal. Therefore, the characteristic curve of the driving module 101 is restored to the normal threshold voltage corresponding to when the data signal is written as soon as possible, thereby effectively avoiding the change of the light-emitting brightness at the beginning of the light-emitting stage.

In the light-emitting stage f of the refresh frame F1, the first light-emitting control module 107 is turned on under a control of the light-emitting control signal provided by the light-emitting control signal terminal EM, the second light-emitting control module 109 is turned on under a control of the light-emitting control signal provided by the light-emitting control signal terminal EM, the driving module 101 is turned on under a control of the first node N1, and the light-emitting element D emits light.

In the first bias stage p1 of the hold frame F2, the data writing module 103 is turned on in response to the turn-on level output by the second scan signal terminal Scn2. The first bias signal provided by the data signal terminal data is transmitted to the first terminal of the driving module 101 through the turned-on data writing module 103. Since the first node N1 is at a low level, the driving module 101 is turned on, and the first bias signal provided by the data signal terminal data is transmitted to the second terminal of the driving module 101 through the turned-on driving module 101. Therefore, the potential of the second terminal of the driving module 101 is greater than or equal to the potential of the control terminal of the driving module 101, thereby adjusting the threshold voltage Vth of the driving module by the first bias signal.

In the second bias stage p2 of the hold frame F2, the data writing module 103 is turned on in response to the turn-on level output by the second scan signal terminal Scn2. The first bias signal provided by the data signal terminal data is transmitted to the first terminal of the driving module 101 through the turned-on data writing module 103. Since the first node N1 is at a low level, the driving module 101 is turned on, and the first bias signal provided by the data signal terminal data is transmitted to the second terminal of the driving module 101 through the turned-on driving module 101. Therefore, the potential of the second terminal of the driving module 101 is greater than or equal to the potential of the control terminal of the driving module 101, thereby adjusting the threshold voltage Vth of the driving module by the first bias signal.

In the light-emitting stage f of the hold frame F2, the first light-emitting control module 107 is turned on under a control of the light-emitting control signal provided by the light-emitting control signal terminal EM, the second light-emitting control module 109 is turned on under a control of the light-emitting control signal provided by the light-emitting control signal terminal EM, the driving module 101 is turned on under a control of the first node N1, and the light-emitting element D emits light.

It should be noted that although FIG. 29 illustrates only one hold frame F2, combining FIGS. 26 and 29, in some embodiments, a picture refresh cycle may include a plurality of hold frames F2, and the timing of the other hold frames F2 in the picture refresh cycle may refer to the timing of the hold frame F2 shown in FIG. 29.

Continuing referring to FIG. 28, in some specific embodiments, optionally, the driving module 101 includes a first transistor M1, the data writing module 103 includes a second transistor M2, the threshold compensation module 104 includes a third transistor M3, the first reset module 105 includes a fourth transistor M4, the first light-emitting control module 107 includes a fifth transistor M5, the second light-emitting control module 109 includes a sixth transistor M6, the second reset module 108 includes a seventh transistor M7, and the storage module 110 includes a storage capacitor Cst.

The gate of the first transistor M1 is electrically connected to the first node N1, the first electrode of the first transistor M1 is electrically connected to the second node N2, and the second electrode of the first transistor M1 is electrically connected to the third node N3.

The gate of the second transistor M2 is electrically connected to the second scan signal terminal Scn2, the first electrode of the second transistor M2 is electrically connected to the data signal terminal data, and the second electrode of the second transistor M2 is electrically connected to the second node N2 or the third node N3;

The gate of the third transistor M3 is electrically connected to the third scan signal terminal Scn3, the first electrode of the third transistor M3 is electrically connected to the first node N1, and the second electrode of the third transistor M3 is electrically connected to the third node N3;

The gate of the fourth transistor M4 is electrically connected to the fourth scan signal terminal Scn4, the first electrode of the fourth transistor M4 is electrically connected to the first initialization signal terminal Vref1, and the second electrode of the fourth transistor M4 is electrically connected to the first node N1;

The gate of the fifth transistor M5 is electrically connected to the light-emitting control signal line EM, the first electrode of the fifth transistor M5 is electrically connected to the third node N3, and the second electrode of the fifth transistor M5 is electrically connected to the first electrode of the light-emitting element D;

The gate of the sixth transistor M6 is electrically connected to the light-emitting control signal line EM, the first electrode of the sixth transistor M6 is electrically connected to the first power signal terminal PVDD, and the second electrode of the sixth transistor M6 is electrically connected to the second node N2;

The gate of the seventh transistor M7 is electrically connected to the sixth scan signal terminal Scn6, the first electrode of the seventh transistor M7 is electrically connected to the second initialization signal terminal Vref2, and the second electrode of the seventh transistor M7 is electrically connected to the first electrode of the light-emitting element D;

The first plate of the storage capacitor Cst is electrically connected to the first power signal terminal PVDD, and the second plate of the storage capacitor Cst is electrically connected to the first node N1.

In some embodiments, the third transistor M3 and the fourth transistor M4 may be N-type transistors, and the first transistor M1, the second transistor M2, the fifth transistor M5, the sixth transistor M6 and the seventh transistor M7 may be P-type transistors.

In some embodiments, the third transistor M3 and the fourth transistor M4 may be oxide thin film transistors, such as indium gallium zinc oxide thin film transistors. The first transistor M1, the second transistor M2, the fifth transistor M5, the sixth transistor M6 and the seventh transistor M7 may be low-temperature polycrystalline silicon thin film transistors.

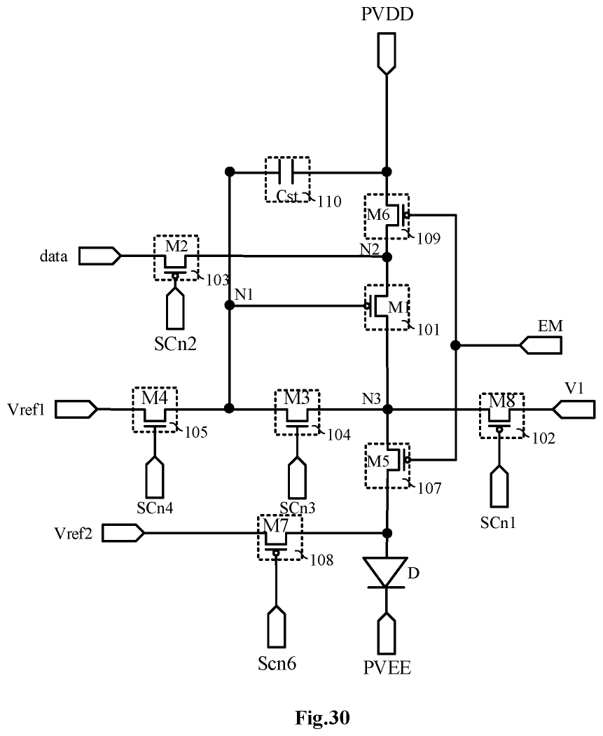

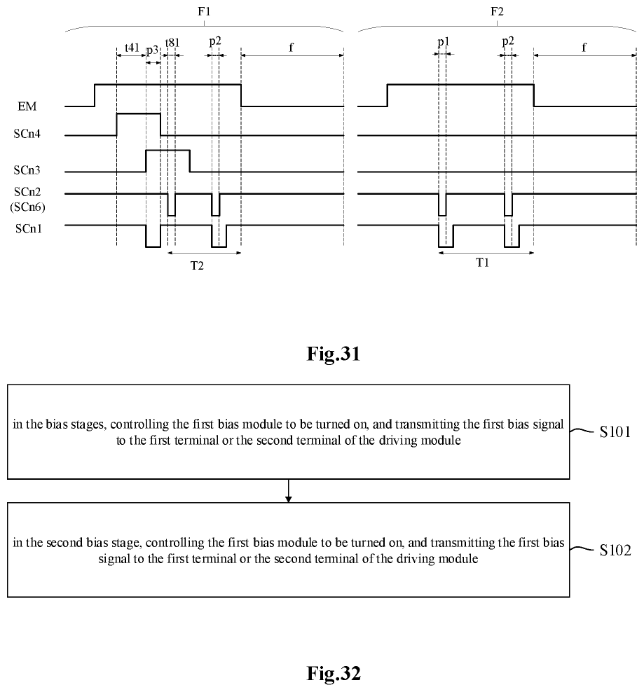

FIG. 30 is another circuit diagram of a pixel circuit provided by an embodiment of the present application. As shown in FIG. 30, unlike the embodiment shown in FIG. 28, in other specific embodiments, optionally, the data writing module may not be reused as the first bias module. Specifically, the control terminal of the first bias module 102 may be electrically connected to the first scan signal terminal Scn1, the first terminal of the first bias module 102 may be electrically connected to the first bias signal terminal V1, and the second terminal of the first bias module 102 may be electrically connected to the first terminal or the second terminal of the drive module 101.

Further, the pixel circuit 10 may also include a driving module 101, a data writing module 103, a threshold compensation module 104, a first reset module 105, a first light-emitting control module 107, a second reset module 108, a second light-emitting control module 109, and a storage module 110. The specific structures and connections of these modules are the same as the embodiment shown in FIG. 28, which will not be described herein for the sake of simplicity.

FIG. 31 is another time sequence diagram of a pixel circuit provided by an embodiment of the present application. Combining FIGS. 30 and 31, the refresh frame F1 may include an initialization stage t41, a third bias stage p3, a data writing stage t81, a second bias stage p2, and a light-emitting stage f arranged in time sequence. Here, the data writing stage t81 in the refresh frame F1 may be the same stage as the first bias stage p1 in the refresh frame F1. The hold frame F2 may include a first bias stage p1, a second bias stage p2, and a light-emitting stage f arranged in time sequence.

In the initialization stage t41 of the refresh frame F1, the threshold compensation module 104 is turned off under a control of the third scan signal provided by the third scan signal terminal Scn3. The first reset module 105 is turned on under a control of the fourth scan signal provided by the fourth scan signal terminal Scn4. The first initialization signal output by the first initialization signal terminal Vref1 is transmitted to the control terminal (i.e., the first node N1) of the driving module 101, thereby achieving reset of the first node N1.

In the third bias stage p3 of the refresh frame F1, the threshold compensation module 104 is turned on under a control of the third scan signal provided by the third scan signal terminal Scn3. The first reset module 105 is turned on under a control of the fourth scan signal provided by the fourth scan signal terminal Scn4. The first bias module 102 is turned on under a control of the fifth scan signal provided by the first scan signal terminal Scn1. The second bias signal output by the first initialization signal terminal Vref1 is transmitted to the control terminal of the driving module 101 and the second terminal of the driving module 101. The first bias signal output by the first bias signal terminal V1 is transmitted to the first terminal or the second terminal of the driving module 101. Therefore, the driving module 101 may be in the OBS state, thereby achieving the adjustment of the threshold voltage Vth of the driving module 101.

In the data writing stage t81 of the refresh frame F1, the data writing module 103 is turned on in response to the turn-on level output by the second scan signal terminal Scn2, and the data signal provided by the data signal terminal data is transmitted to the first terminal of the driving module 101 through the turned-on data writing module 103. Under a control of the third scan signal provided by the third scan signal terminal Scn3, the threshold compensation module 104 is turned on to connect the control terminal of the driving module 101 with the second terminal of the driving module 101, thereby compensating for the threshold voltage of the driving module 101 together with the data writing module 103.

In the second bias stage p2 of the refresh frame F1, the data writing module 103 is turned on in response to the turn-on level output by the second scan signal terminal Scn2. The threshold compensation module 104 is turned off under a control of the third scan signal provided by the third scan signal terminal Scn3. The first bias signal provided by the data signal terminal data is transmitted to the first terminal of the driving module 101 through the turned-on data writing module 103. Since the first node N1 is at a low level, the driving module 101 is turned on, and the first bias signal provided by the data signal terminal data is transmitted to the second terminal of the driving module 101 through the turned-on driving module 101. Therefore, the potential of the second terminal of the driving module 101 is greater than or equal to the potential of the control terminal of the driving module 101, thereby further adjusting the threshold voltage Vth of the driving module by the first bias signal. Therefore, the characteristic curve of the driving module 101 is restored to the normal threshold voltage corresponding to when the data signal is written as soon as possible, thereby effectively avoiding the change of the light-emitting brightness at the beginning of the light-emitting stage.

Alternatively, in the second bias stage p2 of the refresh frame F1, the first bias module 102 is turned on under a control of the fifth scan signal provided by the first scan signal terminal Scn1, and the first bias signal output by the first bias signal terminal V1 is transmitted to the first terminal or the second terminal of the driving module 101. Therefore, the driving module 101 may be in the OBS state, thereby achieving the adjustment of the threshold voltage Vth of the driving module 101.

In the light-emitting stage f of the refresh frame F1, the first light-emitting control module 107 is turned on under a control of the light-emitting control signal provided by the light-emitting control signal terminal EM, the second light-emitting control module 109 is turned on under a control of the light-emitting control signal provided by the light-emitting control signal terminal EM, the driving module 101 is turned on under a control of the first node N1, and the light-emitting element D emits light.

In the first bias stage p1 and the second bias stage p1 of the hold frame F2, the data writing module 103 is turned on in response to the turn-on level output by the second scan signal terminal Scn2. The first bias signal provided by the data signal terminal data is transmitted to the first terminal of the driving module 101 through the turned-on data writing module 103. Since the first node N1 is at a low level, the driving module 101 is turned on, and the first bias signal provided by the data signal terminal data is transmitted to the second terminal of the driving module 101 through the turned-on driving module 101. Therefore, the potential of the second terminal of the driving module 101 is greater than or equal to the potential of the control terminal of the driving module 101, thereby adjusting the threshold voltage Vth of the driving module by the first bias signal.

Alternatively, in the first bias stage p1 and the second bias stage p1 of the hold frame F2, the first bias module 102 is turned on under a control of the fifth scan signal provided by the first scan signal terminal Scn1, and the first bias signal output by the first bias signal terminal V1 is transmitted to the first terminal or the second terminal of the driving module 101. Therefore, the driving module 101 may be in the OBS state, thereby achieving the adjustment of the threshold voltage Vth of the driving module 101.

In the light-emitting stage f of the hold frame F2, the first light-emitting control module 107 is turned on under a control of the light-emitting control signal provided by the light-emitting control signal terminal EM, the second light-emitting control module 109 is turned on under a control of the light-emitting control signal provided by the light-emitting control signal terminal EM, the driving module 101 is turned on under a control of the first node N1, and the light-emitting element D emits light.

It should be noted that although FIG. 31 illustrates only one hold frame F2, combining FIGS. 26 and 31, in some embodiments, a picture refresh cycle H may include a plurality of hold frames F2, and the timing of the other hold frames F2 in the picture refresh cycle may refer to the timing of the hold frame F2 shown in FIG. 31.

Continuing referring to FIG. 30, in some embodiments, optionally, the driving module 101 includes a first transistor M1, the data writing module 103 includes a second transistor M2, the threshold compensation module 104 includes a third transistor M3, the first reset module 105 includes a fourth transistor M4, the first light-emitting control module 107 includes a fifth transistor M5, the second light-emitting control module 109 includes a sixth transistor M6, the second reset module 108 includes a seventh transistor M7, the first bias module 102 includes an eighth transistor M8, and the storage module 110 includes a storage capacitor Cst.

The gate of the first transistor M1 is electrically connected to the first node N1, the first electrode of the first transistor M1 is electrically connected to the second node N2, and the second electrode of the first transistor M1 is electrically connected to the third node N3.

The gate of the second transistor M2 is electrically connected to the second scan signal terminal Scn2, the first electrode of the second transistor M2 is electrically connected to the data signal terminal data, and the second electrode of the second transistor M2 is electrically connected to the second node N2 or the third node N3;

The gate of the third transistor M3 is electrically connected to the third scan signal terminal Scn3, the first electrode of the third transistor M3 is electrically connected to the first node N1, and the second electrode of the third transistor M3 is electrically connected to the third node N3;

The gate of the fourth transistor M4 is electrically connected to the fourth scan signal terminal Scn4, the first electrode of the fourth transistor M4 is electrically connected to the first initialization signal terminal Vref1, and the second electrode of the fourth transistor M4 is electrically connected to the first node N1;

The gate of the fifth transistor M5 is electrically connected to the light-emitting control signal line EM, the first electrode of the fifth transistor M5 is electrically connected to the third node N3, and the second electrode of the fifth transistor M5 is electrically connected to the first electrode of the light-emitting element D;

The gate of the sixth transistor M6 is electrically connected to the light-emitting control signal line EM, the first electrode of the sixth transistor M6 is electrically connected to the first power signal terminal PVDD, and the second electrode of the sixth transistor M6 is electrically connected to the second node N2;

The gate of the seventh transistor M7 is electrically connected to the sixth scan signal terminal Scn6, the first electrode of the seventh transistor M7 is electrically connected to the second initialization signal terminal Vref2, and the second electrode of the seventh transistor M7 is electrically connected to the first electrode of the light-emitting element D;

The gate of the eighth transistor M8 is electrically connected to the first scan signal terminal Scn1, the first electrode of the eighth transistor M8 is electrically connected to the first bias signal terminal V1, and the second electrode of the eighth transistor M8 is electrically connected to the second node N2 or the third node N3;

The first plate of the storage capacitor Cst is electrically connected to the first power signal terminal PVDD, and the second plate of the storage capacitor Cst is electrically connected to the first node N1.

Based on the same technical concept as the pixel circuit 10 provided by the above embodiments, accordingly, the embodiments of the present application also provide a driving method of a pixel circuit, and the driving method of the pixel circuit can be applied to the pixel circuit 10 provided by the above embodiments.

As shown in FIG. 2, the pixel circuit 10 may include a driving module 101 and a first bias module 102. The driving module 101 may be configured to drive a light-emitting element D to emit light. Here, the light-emitting element D includes, but is not limited to, an organic light-emitting diode (OLED), a mini light-emitting diode (Mini LED), a micro light-emitting diode (Micro LED), or a quantum dot light-emitting diode (QLED). The first bias module 102 is electrically connected to a first terminal or a second terminal of the driving module 101, and the first bias module 102 may be configured to provide a first bias signal to the first terminal or the second terminal of the driving module 101. The first bias signal may be configured to adjust a bias state of the driving module 101. That is, the potential of the second terminal of the driving module 101 may be equal to or greater than the potential of the control terminal of the driving module 101, so that the driving module 101 is in the OBS state, thereby realizing the adjustment of the threshold voltage Vth of the driving module 101.

A light-emitting cycle of the light-emitting element includes a refresh frame F1 or a hold frame F2. A control terminal of the driving module is refreshed in the refresh frame F1, and the control terminal of the driving module is not refreshed in the hold frame F2. Each of the refresh frame F1 and the hold frame F2 includes a first stage and a second stage, the first stage is located before the second stage, the first stage includes one or more bias stages, and the second stage includes a light-emitting stage of the light-emitting element.

FIG. 32 is a flow diagram of a driving method of a pixel circuit provided by an embodiment of the present application. As shown in FIG. 32, the driving method of the pixel circuit may include the following step S101.

S101: in the bias stages, controlling the first bias module to be turned on, and transmitting the first bias signal to the first terminal or the second terminal of the driving module.

Here, a turn-on duration of the first bias module in the hold frame F2 is greater than a turn-on duration of the first bias module in the refresh frame F1; and/or a time interval between a turn-on start moment of the first bias module in the hold frame F2 and the light-emitting stage in the hold frame F2 is greater than a time interval between a turn-on start moment of the first bias module in the refresh frame F1 and the light-emitting stage in the refresh frame F1; and/or a turn-on stage of the first bias module in the refresh frame at least partially overlaps with other bias stages in the refresh frame.

According to the driving method of the pixel circuit provided by the embodiments of the present application, by increasing the turn-on duration of the first bias module in the hold frame, and/or increasing the time interval between the turn-on start moment of the first bias module in the hold frame and the light-emitting stage in the hold frame, and/or at least partially overlapping the turn-on stage of the first bias module in the refresh frame with other bias stages in the refresh frame, the time period that the driving module is in the on-bias state in the hold frame may be increased and/or the time period that the driving module is in the on-bias state in the refresh frame may be reduced. Further, the difference between the threshold voltage of the driving module in the hold frame and the threshold voltage of the driving module in the refresh frame may be improved, the difference between the brightness of the refresh frame and the brightness of the hold frame may be reduced, and the flashing problem may be improved.

In some embodiments, a control terminal of the first bias module is electrically connected to a first scan signal terminal, a first terminal of the first bias module is electrically connected to a first bias signal terminal, and a second terminal of the first bias module is electrically connected to the first terminal or the second terminal of the driving module. Under a control of a first scan signal provided by the first scan signal terminal, the first bias module transmits the first bias signal provided by the first bias signal terminal to the first terminal or the second terminal of the driving module. In the refresh frame and the hold frame, the bias stages include a first bias stage.

S101 may specifically include: in the first bias stage, controlling the first bias module to be turned on, and transmitting the first bias signal to the first terminal or the second terminal of the driving module.

In some embodiments, the first stage of the refresh frame further includes a data writing stage, and at least the bias stages of the refresh frame further include a second bias stage, the second bias stage is located between the data writing stage and the light-emitting stage. FIG. 32 is a flow diagram of a driving method of a pixel circuit provided by an embodiment of the present application. As shown in FIG. 32, the driving method of the pixel circuit may include the following step S102.

S102: in the second bias stage, controlling the first bias module to be turned on, and transmitting the first bias signal to the first terminal or the second terminal of the driving module.

In some embodiments, the pixel circuit further includes a data writing module, a control terminal of the data writing module is electrically connected to a second scan signal terminal, a first terminal of the data writing module is electrically connected to a data signal terminal, and a second terminal of the data writing module is electrically connected to the first terminal or the second terminal of the driving module. The first bias module is reused as the data writing module, the first scan signal terminal is reused as the second scan signal terminal, and the first bias signal terminal is reused as the data signal terminal.

In some embodiments, the bias stages of the refresh frame further include a third bias stage, and the third bias stage at least partially overlaps with the first bias stage. The control terminal of the driving module is electrically connected to a first node, the first terminal of the driving module is electrically connected to a second node, and the second terminal of the driving module is electrically connected to a third node. The pixel circuit further includes a threshold compensation module, a control terminal of the threshold compensation module is electrically connected to a third scan signal terminal, a first terminal of the threshold compensation module is electrically connected to the first node, and a second terminal of the threshold compensation module is electrically connected to the third node. Under a control of a third scan signal provided by the third scan signal terminal, the threshold compensation module is configured to connect the control terminal of the driving module and the second terminal of the driving module. The pixel circuit further includes a first reset module, a control terminal of the first reset module is electrically connected to a fourth scan signal terminal, a first terminal of the first reset module is electrically connected to a first initialization signal terminal, and a second terminal of the first reset module is electrically connected to the first node or the third node.

FIG. 33 is another flow diagram of a driving method of a pixel circuit provided by an embodiment of the present application. As shown in FIG. 33, the driving method of the pixel circuit may include the following step S103.

S103: in the third bias stage, causing the threshold compensation module to be turned on under a control of the third scan signal provided by the third scan signal terminal, causing the first reset module to be turned on under a control of a fourth scan signal provided by the fourth scan signal terminal, and transmitting a second bias signal output by the first initialization signal terminal to the control terminal of the driving module and the second terminal of the driving module, wherein the second bias signal is configured to adjust the bias state of the driving module.

In some embodiments, the control terminal of the driving module is electrically connected to a first node, the first terminal of the driving module is electrically connected to a second node, and the second terminal of the driving module is electrically connected to a third node. The pixel circuit further includes a threshold compensation module, a control terminal of the threshold compensation module is electrically connected to a third scan signal terminal, a first terminal of the threshold compensation module is electrically connected to the first node, and a second terminal of the threshold compensation module is electrically connected to the third node. Under a control of a third scan signal provided by the third scan signal terminal, the threshold compensation module is configured to connect the control terminal of the driving module and the second terminal of the driving module. The pixel circuit further includes a first reset module, a control terminal of the first reset module is electrically connected to a fourth scan signal terminal, a first terminal of the first reset module is electrically connected to a first initialization signal terminal, and a second terminal of the first reset module is electrically connected to the first node or the third node. The bias stages of the refresh frame further include a third bias stage, and the third bias stage is located before the first bias stage.

As shown in FIG. 33, the driving method of the pixel circuit may include the following step S103.

S103: in the third bias stage, causing the threshold compensation module to be turned on under a control of the third scan signal provided by the third scan signal terminal, causing the first reset module to be turned on under a control of a fourth scan signal provided by the fourth scan signal terminal, and transmitting a second bias signal output by the first initialization signal terminal to the control terminal of the driving module and the second terminal of the driving module, wherein the second bias signal is configured to adjust the bias state of the driving module.

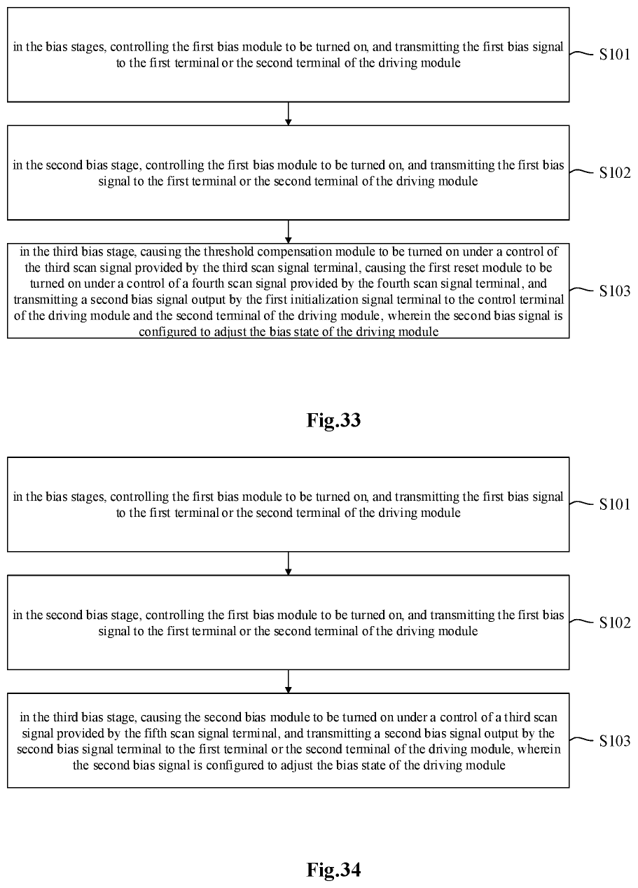

In some embodiments, the pixel circuit further includes a second bias module, a control terminal of the second bias module is electrically connected to a fifth scan signal terminal, a first terminal of the second bias module is electrically connected to a second bias signal terminal, and a second terminal of the second bias module is electrically connected to the first terminal or the second terminal of the driving module. The bias stages of the refresh frame further include a third bias stage, and the third bias stage is located before the first bias stage. FIG. 34 is another flow diagram of a driving method of a pixel circuit provided by an embodiment of the present application. As shown in FIG. 34, the driving method of the pixel circuit may include the following step S103.

S103: in the third bias stage, causing the second bias module to be turned on under a control of a third scan signal provided by the fifth scan signal terminal, and transmitting a second bias signal output by the second bias signal terminal to the first terminal or the second terminal of the driving module, wherein the second bias signal is configured to adjust the bias state of the driving module.

It should be noted that the specific process of the above steps S101 to S103 is described in detail in the pixel circuit 10 provided by the above embodiments, and will not be described herein for the sake of simplicity. Moreover, for the sake of simplicity, some of the technical features of the driving method of the pixel circuit provided by the embodiments of the present application are not listed. However, it is easy to understand that the driving method of the pixel circuit provided by the embodiments of the present application has the same or corresponding technical features as the pixel circuit 10. That is, all of the technical features of the pixel circuit 10 provided by the above embodiments are applicable to the driving method of the pixel circuit provided by the embodiments of the present application.

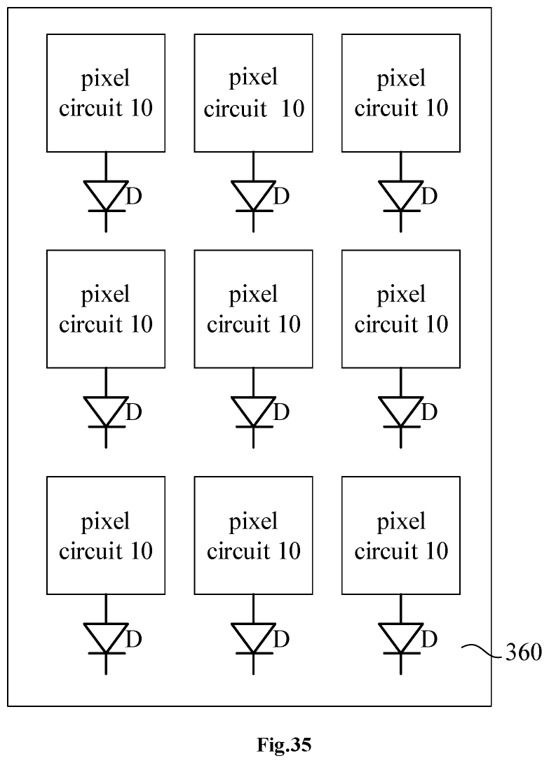

FIG. 35 is a structural diagram of a display panel provided by an embodiment of the present application. As shown in FIG. 35, the present application further provides a display panel 360. The display panel 360 may include the pixel circuit 10 provided by the embodiments of the present application.

The display panel 360 provided by the embodiments of the present application has the beneficial effects of the pixel circuit 10 provided by the embodiments of the present application. For details, please refer to the specific description of the pixel circuit 10 in the above embodiments, which will not be repeated here.

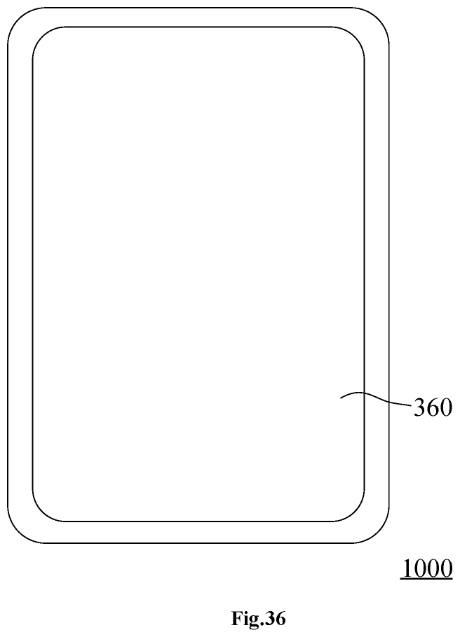

Based on the display panel 360 provided in the above embodiments, accordingly, the present application also provides a display device, including the display panel provided by the present application. Referring to FIG. 36, FIG. 36 is a structural diagram of a display device provided by an embodiment of the present application. The display device 1000 provided in FIG. 36 includes the display panel 360 provided in any of the above embodiments of the present application. The embodiment of FIG. 36 illustrates the display device 1000 as a mobile phone. It is understood that the display device provided by the embodiments of the present application may be a display device with display functions such as a wearable product, a computer, a TV, or an on-board display device, which is not specifically limited in the present application. The display device provided by the embodiments of the present application has the beneficial effects of the display panel 360 and the pixel circuit 10 provided by the embodiments of the present application. For details, please refer to the specific description of the display panel 360 and the pixel circuit 10 in the above embodiments, which will not be repeated here.

It should be understood that the specific structures of the pixel circuit and the display panel provided in the illustrated embodiments of the present application are only some examples, and are not intended to limit the present application. Further, in the case of not contradictory, the above embodiments provided in the present application may be combined with each other.

It should be clear that the present application is not limited to the specific configuration and processing described above and illustrated in figures. For the sake of simplicity, a detailed description of the known methods is omitted here. In the above embodiments, several specific steps are described and illustrated as examples. However, the method process of the present application is not limited to the specific steps described and shown, and after understanding the spirit of the present application, those skilled in the art can may make changes, modifications and additions, or may change the order of the steps.

The functional blocks shown in the structural views described above may be implemented as hardware, software, firmware, or a combination thereof. When implemented as hardware, it may be, for example, an electronic circuit, an application specific integrated circuit (ASIC), appropriate firmware, plugins, function cards, etc. When implemented as software, elements of the present application are programs or code segments for performing required tasks. The programs or code segments may be stored in a machine-readable medium, or transmitted on a transmission medium or a communication link through a data signal carried in a carrier wave. The “machine-readable medium” may include any medium that can store or transmit information. Examples of the machine-readable medium include an electronic circuit, a semiconductor memory device, a ROM, a flash memory, an erasable ROM (EROM), a floppy disk, a CD-ROM, an optical disk, a hard disk, a fiber optic medium, a radio frequency (RF) link, and so on. The code segments may be downloaded via a computer network such as the Internet, intranet, and so on.

It should also be noted that according to the exemplary embodiments described in the present application, some methods or systems are described based on a series of steps or apparatuses. However, the present application is not limited to the above order of the steps. That is, the steps may be executed in the order described in the embodiments or in orders different from that in the embodiments, or several steps may be executed simultaneously.

Aspects of the present application are described above with reference to flowcharts and/or block diagrams of methods, devices (systems) and machine program products according to embodiments of the present application. It will be understood that each block of the flowcharts and/or block diagrams, and combinations of blocks of the flowcharts and/or block diagrams, can be implemented by computer program instructions. These computer program instructions may be provided to a processor of a general purpose computer, a special purpose computer, or other programmable data processing device to produce a machine, such that these instructions executed by the processor of the computer or other programmable data processing device can enable implementation of the functions/acts specified in one or more blocks of the flowcharts and/or block diagrams. Such a processor may be, but not limited to, a general purpose processor, a special purpose processor, an application specific processor, or a field programmable logic circuit. It will also be understood that each block of the block diagrams and/or flowcharts, and combinations of blocks of the block diagrams and/or flowcharts, can also be implemented by special purpose hardware for performing specified functions or actions, or can be implemented by a combination of special purpose hardware and computer instructions.

The above are only specific implementations of the present application, those skilled in the art can clearly understand that, for the convenience and brevity of the description, the specific working processes of the above-described systems, modules and units can be referred to the corresponding processes in the foregoing method embodiments, which is not repeated here. It should be understood that, the protection scope of the present application is not limited to this, and any person skilled in the art can easily think of various equivalent modifications or replacements within the technical scope disclosed in the present application, and these modifications or replacements should all be covered within the scope of protection of the present application.

What is claimed is:

1. A pixel circuit, comprising:
a driving module configured to drive a light-emitting element to emit light;
a first bias module electrically connected to a first terminal or a second terminal of the driving module, wherein the first bias module is configured to provide a first bias signal to the first terminal or the second terminal of the driving module, and the first bias signal is configured to adjust a bias state of the driving module;
wherein a light-emitting cycle of the light-emitting element comprises a refresh frame or a hold frame, wherein a control terminal of the driving module is refreshed in the refresh frame, and the control terminal of the driving module is not refreshed in the hold frame; each of the refresh frame and the hold frame comprises a first stage and a second stage, the first stage is located before the second stage, the first stage comprises one or more bias stages, and the second stage comprises a light-emitting stage of the light-emitting element, and wherein in the bias stages, the first bias module is turned on, and the first bias signal is transmitted to the first terminal or the second terminal of the driving module;
wherein a turn-on duration of the first bias module in the hold frame is longer than a turn-on duration of the first bias module in the refresh frame; and/or,
a time interval between a turn-on start moment of the first bias module in the hold frame and the light-emitting stage in the hold frame is greater than a time interval between a turn-on start moment of the first bias module in the refresh frame and the light-emitting stage in the refresh frame; and/or a turn-on stage of the first bias module in the refresh frame at least partially overlaps with other bias stages in the refresh frame.

2. The pixel circuit according to claim 1, wherein a control terminal of the first bias module is electrically connected to a first scan signal terminal, a first terminal of the first bias module is electrically connected to a first bias signal terminal, and a second terminal of the first bias module is electrically connected to the first terminal or the second terminal of the driving module, and wherein under a control of a first scan signal provided by the first scan signal terminal, the first bias module transmits the first bias signal provided by the first bias signal terminal to the first terminal or the second terminal of the driving module;
in the refresh frame and the hold frame, the bias stages comprise a first bias stage, wherein in the first bias stage, the first bias module is turned on, and the first bias signal is transmitted to the first terminal or the second terminal of the driving module.

3. The pixel circuit according to claim 2, wherein in the refresh frame and the hold frame, the first scan signal comprises one or more pulses for controlling the first bias module to be turned on, and the pulses comprise 1^{st} to M^{th} pulses arranged at intervals in time sequence, where M is a positive integer;
a time interval between a turn-on moment of the 1^{st} pulse of the first scan signal in the hold frame and the light-emitting stage in the hold frame is a first time interval, and a time interval between a turn-on moment of the 1^{st} pulse of the first scan signal in the refresh frame and the light-emitting stage in the refresh frame is a second time interval, and wherein the first time interval is greater than the second time interval.

4. The pixel circuit according to claim 3, wherein a width of the pulse in the hold frame is equal to a width of the pulse in the refresh frame.

5. The pixel circuit according to claim 2, wherein in the refresh frame and the hold frame, the first scan signal comprises one or more pulses for controlling the first bias module to be turned on;
a width of at least one of the pulses in the hold frame is greater than a width of at least one of the pulses in the refresh frame.

6. The pixel circuit according to claim 2, wherein in the refresh frame, the first scan signal comprises N1 pulses for controlling the first bias module to be turned on, and the N1 pulses are arranged at intervals in time sequence, wherein N1 is a positive integer;
in the hold frame, the first scan signal comprises N2 pulses for controlling the first bias module to be turned on, and the N2 pulses are arranged at intervals in time sequence, wherein N2>N1 and N2 is a positive integer.

7. The pixel circuit according to claim 6, wherein
a time interval between a turn-on moment of a 1^{st} pulse of the first scan signal in the hold frame and the light-emitting stage in the hold frame is a first time interval, and a time interval between a turn-on moment of a 1^{st} pulse of the first scan signal in the refresh frame and the light-emitting stage in the refresh frame is a second time interval, and wherein the first time interval is greater than the second time interval.

8. The pixel circuit of claim 2, wherein
the first stage of the refresh frame further comprises a data writing stage, and at least the bias stages of the refresh frame further comprise a second bias stage, the second bias stage is located between the data writing stage and the light-emitting stage, wherein in the second bias stage, the first bias module is turned on, and the first bias signal is transmitted to the first terminal or the second terminal of the driving module.

9. The pixel circuit according to claim 2, wherein the pixel circuit further comprises a data writing module, a control terminal of the data writing module is electrically connected to a second scan signal terminal, a first terminal of the data writing module is electrically connected to a data signal terminal, and a second terminal of the data writing module is electrically connected to the first terminal or the second terminal of the driving module;
the refresh frame further comprises a data writing stage, the data writing stage is located before the light-emitting stage of the refresh frame, wherein in the data writing stage, under a control of a second scan signal provided by the second scan signal terminal, the data writing module is turned on and is configured to transmit a data signal provided by the data signal terminal to the first terminal or the second terminal of the driving module.

10. The pixel circuit according to claim 9, wherein the first bias module is reused as the data writing module, the first scan signal terminal is reused as the second scan signal terminal, and the first bias signal terminal is reused as the data signal terminal.

11. The pixel circuit according to claim 9, wherein
the hold frame further comprises a data writing module turn-on stage, wherein in the hold frame, the data writing module turn-on stage is located before the light-emitting stage, and the data writing module turn-on stage is located after the first bias stage, or a turn-on moment of the data writing module turn-on stage is the same as a turn-on moment of the first bias stage.

12. The pixel circuit according to claim 11, wherein in the refresh frame, the data writing stage is located after the first bias stage.

13. The pixel circuit according to claim 12, wherein the bias stages of the refresh frame further comprise a third bias stage, and the third bias stage at least partially overlaps with the first bias stage;
the control terminal of the driving module is electrically connected to a first node, the first terminal of the driving module is electrically connected to a second node, and the second terminal of the driving module is electrically connected to a third node;
the pixel circuit further comprises a threshold compensation module, a control terminal of the threshold compensation module is electrically connected to a third scan signal terminal, a first terminal of the threshold compensation module is electrically connected to the first node, and a second terminal of the threshold compensation module is electrically connected to the third node, and wherein under a control of a third scan signal provided by the third scan signal terminal, the threshold compensation module is configured to connect the control terminal of the driving module and the second terminal of the driving module;
the pixel circuit further comprises a first reset module, a control terminal of the first reset module is electrically connected to a fourth scan signal terminal, a first terminal of the first reset module is electrically connected to a first initialization signal terminal, and a second terminal of the first reset module is electrically connected to the first node;
wherein in the third bias stage, the threshold compensation module is turned on under a control of the third scan signal provided by the third scan signal terminal, the first reset module is turned on under a control of a fourth scan signal provided by the fourth scan signal terminal, and a second bias signal output by the first initialization signal terminal is transmitted to the control terminal of the driving module and the second terminal of the driving module, wherein the second bias signal is configured to adjust the bias state of the driving module.

14. The pixel circuit according to claim 2, wherein the control terminal of the driving module is electrically connected to a first node, the first terminal of the driving module is electrically connected to a second node, and the second terminal of the driving module is electrically connected to a third node;
the pixel circuit further comprises a threshold compensation module, a control terminal of the threshold compensation module is electrically connected to a third scan signal terminal, a first terminal of the threshold compensation module is electrically connected to the first node, and a second terminal of the threshold compensation module is electrically connected to the third node, and wherein under a control of a third scan signal provided by the third scan signal terminal, the threshold compensation module is configured to connect the control terminal of the driving module and the second terminal of the driving module;
the pixel circuit further comprises a first reset module, a control terminal of the first reset module is electrically connected to a fourth scan signal terminal, a first terminal of the first reset module is electrically connected to a first initialization signal terminal, and a second terminal of the first reset module is electrically connected to the first node;
the bias stages of the refresh frame further comprise a third bias stage, and the third bias stage is located before the first bias stage, and wherein in the third bias stage, the threshold compensation module is turned on under a control of the third scan signal provided by the third scan signal terminal, the first reset module is turned on under a control of a fourth scan signal provided by the fourth scan signal terminal, and a second bias signal output by the first initialization signal terminal is transmitted to the control terminal of the driving module and the second terminal of the driving module, wherein the second bias signal is configured to adjust the bias state of the driving module.

15. The pixel circuit according to claim 2, wherein the control terminal of the driving module is electrically connected to a first node, the first terminal of the driving module is electrically connected to a second node, and the second terminal of the driving module is electrically connected to a third node;
the pixel circuit further comprises a threshold compensation module, a control terminal of the threshold compensation module is electrically connected to a third scan signal terminal, a first terminal of the threshold compensation module is electrically connected to the first node, and a second terminal of the threshold compensation module is electrically connected to the third node, and wherein under a control of a third scan signal provided by the third scan signal terminal, the threshold compensation module is configured to connect the control terminal of the driving module and the second terminal of the driving module;
the pixel circuit further comprises a first reset module, a control terminal of the first reset module is electrically connected to a fourth scan signal terminal, a first terminal of the first reset module is electrically connected to a first initialization signal terminal, and a second terminal of the first reset module is electrically connected to the third node;
the bias stages of the refresh frame further comprise a third bias stage, and the third bias stage is located before the first bias stage, and wherein in the third bias stage, the threshold compensation module is turned on under a control of the third scan signal provided by the third scan signal terminal, the first reset module is turned on under a control of a fourth scan signal provided by the fourth scan signal terminal, and a second bias signal output by the first initialization signal terminal is transmitted to the control terminal of the driving module and the second terminal of the driving module, wherein the second bias signal is configured to adjust the bias state of the driving module.

16. The pixel circuit according to claim 15, wherein the first bias module is reused as the first reset module, and wherein in the first bias stage, the first reset module is turned on, and the first bias signal output by the first initialization signal terminal is transmitted to the second terminal of the driving module.

17. The pixel circuit according to claim 2, wherein the pixel circuit further comprises a second bias module, a control terminal of the second bias module is electrically connected to a fifth scan signal terminal, a first terminal of the second bias module is electrically connected to a second bias signal terminal, and a second terminal of the second bias module is electrically connected to the first terminal or the second terminal of the driving module;
the bias stages of the refresh frame further comprise a third bias stage, and the third bias stage is located before the first bias stage, and wherein in the third bias stage, the second bias module is turned on under a control of a third scan signal provided by the fifth scan signal terminal, and a second bias signal output by the second bias signal terminal is transmitted to the first terminal or the second terminal of the driving module, wherein the second bias signal is configured to adjust the bias state of the driving module.

18. The pixel circuit according to claim 14, wherein the pixel circuit further comprises a second bias module, a control terminal of the second bias module is electrically connected to a fifth scan signal terminal, a first terminal of the second bias module is electrically connected to a second bias signal terminal, and a second terminal of the second bias module is electrically connected to the first terminal or the second terminal of the driving module;
the bias stages of the refresh frame further comprise a third bias stage, and the third bias stage is located before the first bias stage, and wherein in the third bias stage, the second bias module is turned on under a control of a fifth scan signal provided by the fifth scan signal terminal, and a third bias signal output by the second bias signal terminal is transmitted to the first terminal or the second terminal of the driving module, wherein the third bias signal is configured to adjust the bias state of the driving module.

19. The pixel circuit according to claim 2, wherein the pixel circuit further comprises a first light-emitting control module, a control terminal of the first light-emitting control module is electrically connected to a light-emitting control signal line, a first terminal of the first light-emitting control module is electrically connected to the second terminal of the driving module, and a second terminal of the first light-emitting control module is electrically connected to a first electrode of the light-emitting element;
the pixel circuit further comprises a second reset module, a control terminal of the second reset module is electrically connected to a sixth scan signal terminal, a first terminal of the second reset module is electrically connected to a second initialization signal terminal, and a second terminal of the second reset module is electrically connected to the first electrode of the light-emitting element;
the bias stages of the refresh frame further comprise a third bias stage, and the third bias stage is located before the first bias stage, and wherein in the third bias stage, the first light-emitting control module is turned on under a control of a light-emitting control signal provided by the light-emitting control signal terminal, the second reset module is turned on under a control of a sixth scan signal provided by the sixth scan signal terminal, and a second bias signal output by the second initialization signal terminal is transmitted to the second terminal of the driving module, wherein the second bias signal is configured to adjust the bias state of the driving module.

20. The pixel circuit according to claim 2, wherein the pixel circuit is applied in a display panel, and a picture refresh cycle of the display panel comprises one refresh frame and at least two hold frames;
in a same picture refresh cycle, the turn-on duration of the first bias module in the i^{th} hold frame is equal to the turn-on duration of the first bias module in the (i+1)^{th} hold frame, where i is a positive integer; and/or
in a same picture refresh cycle, the time interval between the turn-on start moment of the first bias module in the i^{th} hold frame and the light-emitting stage in the i^{th} hold frame is equal to the time interval between the turn-on start moment of the first bias module in the (i+1)^{th} hold frame and the light-emitting stage in the (i+1)^{th} hold frame.

21. The pixel circuit according to claim 20, wherein the turn-on duration of the first bias module in the i^{th} hold frame being equal to the turn-on duration of the first bias module in the (i+1)^{th} hold frame comprises:
a number of pulses of the first scan signal in the i^{th} hold frame is equal to a number of pulses of the first scan signal in the (i+1)^{th} hold frame; and/or
a width of the pulse of the first scan signal in the i^{th} hold frame is equal to a width of the pulse of the first scan signal in the (i+1)^{th} hold frame.

22. The pixel circuit according to claim 2, wherein the pixel circuit further comprises a second bias module, and the second bias module is electrically connected to the first terminal or the second terminal of the driving module;
the bias stages of the refresh frame further comprise a third bias stage, and the third bias stage is located before the first bias stage, and wherein in the third bias stage, the second bias module is turned on, and a second bias signal is transmitted to the first terminal or the second terminal of the driving module, wherein the second bias signal is configured to adjust the bias state of the driving module;
the time interval between the turn-on start moment of the first bias module in the hold frame and the light-emitting stage in the hold frame is equal to a time interval between a turn-on start moment of the second bias module in the refresh frame and the light-emitting stage in the refresh frame.

23. The pixel circuit according to claim 10, wherein the control terminal of the driving module is electrically connected to a first node, the first terminal of the driving module is electrically connected to a second node, and the second terminal of the driving module is electrically connected to a third node;
the pixel circuit further comprises:
a threshold compensation module, wherein a control terminal of the threshold compensation module is electrically connected to a third scan signal terminal, a first terminal of the threshold compensation module is electrically connected to the first node, and a second terminal of the threshold compensation module is electrically connected to the third node, and wherein under a control of a third scan signal provided by the third scan signal terminal, the threshold compensation module is configured to connect the control terminal of the driving module and the second terminal of the driving module;
a first reset module, wherein a control terminal of the first reset module is electrically connected to a fourth scan signal terminal, a first terminal of the first reset module is electrically connected to a first initialization signal terminal, and a second terminal of the first reset module is electrically connected to the first node;
a first light-emitting control module, wherein a control terminal of the first light-emitting control module is electrically connected to a light-emitting control signal line, a first terminal of the first light-emitting control module is electrically connected to the second terminal of the driving module, and a second terminal of the first light-emitting control module is electrically connected to a first electrode of the light-emitting element;
a second light-emitting control module, wherein a control terminal of the second light-emitting control module is electrically connected to the light-emitting control signal line, a first terminal of the second light-emitting control module is electrically connected to a first power signal terminal, and a second terminal of the second light-emitting control module is electrically connected to the second node;
a second reset module, wherein a control terminal of the second reset module is electrically connected to a sixth scan signal terminal, a first terminal of the second reset module is electrically connected to a second initialization signal terminal, and a second terminal of the second reset module is electrically connected to the first electrode of the light-emitting element;
a storage module, wherein a first terminal of the storage module is electrically connected to the first power signal terminal, and a second terminal of the storage module is electrically connected to the first node;
the bias stages of the refresh frame further comprise a third bias stage, and the third bias stage is located before the first bias stage, and wherein in the third bias stage, the threshold compensation module is turned on under a control of the third scan signal provided by the third scan signal terminal, the first reset module is turned on under a control of a fourth scan signal provided by the fourth scan signal terminal, and a second bias signal output by the first initialization signal terminal is transmitted to the control terminal of the driving module and the second terminal of the driving module, wherein the second bias signal is configured to adjust the bias state of the driving module.

24. The pixel circuit according to claim 23, wherein the driving module comprises a first transistor, the data writing module comprises a second transistor, the threshold compensation module comprises a third transistor, the first reset module comprises a fourth transistor, the first light-emitting control module comprises a fifth transistor, the second light-emitting control module comprises a sixth transistor, the second reset module comprises a seventh transistor, and the storage module comprises a storage capacitor, wherein
a gate of the first transistor is electrically connected to the first node, a first electrode of the first transistor is electrically connected to the second node, and a second electrode of the first transistor is electrically connected to the third node;
a gate of the second transistor is electrically connected to the second scan signal terminal, a first electrode of the second transistor is electrically connected to the data signal terminal, and a second electrode of the second transistor is electrically connected to the second node or the third node;
a gate of the third transistor is electrically connected to the third scan signal terminal, a first electrode of the third transistor is electrically connected to the first node, and a second electrode of the third transistor is electrically connected to the third node;
a gate of the fourth transistor is electrically connected to the fourth scan signal terminal, a first electrode of the fourth transistor is electrically connected to the first initialization signal terminal, and a second electrode of the fourth transistor is electrically connected to the first node;
a gate of the fifth transistor is electrically connected to the light-emitting control signal line, a first electrode of the fifth transistor is electrically connected to the third node, and a second electrode of the fifth transistor is electrically connected to the first electrode of the light-emitting element;
a gate of the sixth transistor is electrically connected to the light-emitting control signal line, a first electrode of the sixth transistor is electrically connected to the first power signal terminal, and a second electrode of the sixth transistor is electrically connected to the second node;
a gate of the seventh transistor is electrically connected to the sixth scan signal terminal, a first electrode of the seventh transistor is electrically connected to the second initialization signal terminal, and a second electrode of the seventh transistor is electrically connected to the first electrode of the light-emitting element;
a first plate of the storage capacitor is electrically connected to the first power signal terminal, and a second plate of the storage capacitor is electrically connected to the first node.

25. The pixel circuit according to claim 13, wherein the control terminal of the driving module is electrically connected to a first node, the first terminal of the driving module is electrically connected to a second node, and the second terminal of the driving module is electrically connected to a third node;
the pixel circuit further comprises:
a first light-emitting control module, wherein a control terminal of the first light-emitting control module is electrically connected to a light-emitting control signal line, a first terminal of the first light-emitting control module is electrically connected to the second terminal of the driving module, and a second terminal of the first light-emitting control module is electrically connected to a first electrode of the light-emitting element;
a second light-emitting control module, wherein a control terminal of the second light-emitting control module is electrically connected to the light-emitting control signal line, a first terminal of the second light-emitting control module is electrically connected to a first power signal terminal, and a second terminal of the second light-emitting control module is electrically connected to the second node;
a second reset module, wherein a control terminal of the second reset module is electrically connected to a sixth scan signal terminal, a first terminal of the second reset module is electrically connected to a second initialization signal terminal, and a second terminal of the second reset module is electrically connected to the first electrode of the light-emitting element;
a storage module, wherein a first terminal of the storage module is electrically connected to the first power signal terminal, and a second terminal of the storage module is electrically connected to the first node.

26. The pixel circuit according to claim 25, wherein the driving module comprises a first transistor, the data writing module comprises a second transistor, the threshold compensation module comprises a third transistor, the first reset module comprises a fourth transistor, the first light-emitting control module comprises a fifth transistor, the second light-emitting control module comprises a sixth transistor, the second reset module comprises a seventh transistor, the first bias module comprises an eighth transistor, and the storage module comprises a storage capacitor, wherein:
a gate of the first transistor is electrically connected to the first node, a first electrode of the first transistor is electrically connected to the second node, and a second electrode of the first transistor is electrically connected to the third node;
a gate of the second transistor is electrically connected to the second scan signal terminal, a first electrode of the second transistor is electrically connected to the data signal terminal, and a second electrode of the second transistor is electrically connected to the second node or the third node;
a gate of the third transistor is electrically connected to the third scan signal terminal, a first electrode of the third transistor is electrically connected to the first node, and a second electrode of the third transistor is electrically connected to the third node;
a gate of the fourth transistor is electrically connected to the fourth scan signal terminal, a first electrode of the fourth transistor is electrically connected to the first initialization signal terminal, and a second electrode of the fourth transistor is electrically connected to the first node;
a gate of the fifth transistor is electrically connected to the light-emitting control signal line, a first electrode of the fifth transistor is electrically connected to the third node, and a second electrode of the fifth transistor is electrically connected to the first electrode of the light-emitting element;
a gate of the sixth transistor is electrically connected to the light-emitting control signal line, a first electrode of the sixth transistor is electrically connected to the first power signal terminal, and a second electrode of the sixth transistor is electrically connected to the second node;
a gate of the seventh transistor is electrically connected to the sixth scan signal terminal, a first electrode of the seventh transistor is electrically connected to the second initialization signal terminal, and a second electrode of the seventh transistor is electrically connected to the first electrode of the light-emitting element;
a gate of the eighth transistor is electrically connected to the first scan signal terminal, a first electrode of the eighth transistor is electrically connected to the first bias signal terminal, and a second electrode of the eighth transistor is electrically connected to the second node or the third node;
a first plate of the storage capacitor is electrically connected to the first power signal terminal, and a second plate of the storage capacitor is electrically connected to the first node.

27. A driving method of a pixel circuit, wherein the pixel circuit comprises: a driving module configured to drive a light-emitting element to emit light; a first bias module electrically connected to a first terminal or a second terminal of the driving module, wherein the first bias module is configured to provide a first bias signal to the first terminal or the second terminal of the driving module, and the first bias signal is configured to adjust a bias state of the driving module;
wherein a light-emitting cycle of the light-emitting element comprises a refresh frame or a hold frame, wherein a control terminal of the driving module is refreshed in the refresh frame, and the control terminal of the driving module is not refreshed in the hold frame; each of the refresh frame and the hold frame comprises a first stage and a second stage, the first stage is located before the second stage, the first stage comprises one or more bias stages, and the second stage comprises a light-emitting stage of the light-emitting element;
the driving method comprises:
in the bias stages, controlling the first bias module to be turned on, and transmitting the first bias signal to the first terminal or the second terminal of the driving module;
wherein a turn-on duration of the first bias module in the hold frame is longer than a turn-on duration of the first bias module in the refresh frame; and/or,
a time interval between a turn-on start moment of the first bias module in the hold frame and the light-emitting stage in the hold frame is greater than a time interval between a turn-on start moment of the first bias module in the refresh frame and the light-emitting stage in the refresh frame; and/or a turn-on stage of the first bias module in the refresh frame at least partially overlaps with other bias stages in the refresh frame.

28. The driving method according to claim 27, wherein a control terminal of the first bias module is electrically connected to a first scan signal terminal, a first terminal of the first bias module is electrically connected to a first bias signal terminal, and a second terminal of the first bias module is electrically connected to the first terminal or the second terminal of the driving module, and wherein under a control of a first scan signal provided by the first scan signal terminal, the first bias module transmits the first bias signal provided by the first bias signal terminal to the first terminal or the second terminal of the driving module;
in the refresh frame and the hold frame, the bias stages comprise a first bias stage;
the driving method further comprises: in the first bias stage, controlling the first bias module to be turned on, and transmitting the first bias signal to the first terminal or the second terminal of the driving module.

29. The driving method according to claim 28, wherein the first stage of the refresh frame further comprises a data writing stage, and at least the bias stages of the refresh frame further comprise a second bias stage, the second bias stage is located between the data writing stage and the light-emitting stage;
the driving method further comprises:
in the second bias stage, controlling the first bias module to be turned on, and transmitting the first bias signal to the first terminal or the second terminal of the driving module.

30. The driving method according to claim 28, wherein the pixel circuit further comprises a data writing module, a control terminal of the data writing module is electrically connected to a second scan signal terminal, a first terminal of the data writing module is electrically connected to a data signal terminal, and a second terminal of the data writing module is electrically connected to the first terminal or the second terminal of the driving module;
the first bias module is reused as the data writing module, the first scan signal terminal is reused as the second scan signal terminal, and the first bias signal terminal is reused as the data signal terminal.

31. The driving method according to claim 28, wherein the bias stages of the refresh frame further comprise a third bias stage, and the third bias stage at least partially overlaps with the first bias stage;
the control terminal of the driving module is electrically connected to a first node, the first terminal of the driving module is electrically connected to a second node, and the second terminal of the driving module is electrically connected to a third node;
the pixel circuit further comprises a threshold compensation module, a control terminal of the threshold compensation module is electrically connected to a third scan signal terminal, a first terminal of the threshold compensation module is electrically connected to the first node, and a second terminal of the threshold compensation module is electrically connected to the third node, and wherein under a control of a third scan signal provided by the third scan signal terminal, the threshold compensation module is configured to connect the control terminal of the driving module and the second terminal of the driving module;
the pixel circuit further comprises a first reset module, a control terminal of the first reset module is electrically connected to a fourth scan signal terminal, a first terminal of the first reset module is electrically connected to a first initialization signal terminal, and a second terminal of the first reset module is electrically connected to the first node or the third node;
the driving method further comprises:
in the third bias stage, causing the threshold compensation module to be turned on under a control of the third scan signal provided by the third scan signal terminal, causing the first reset module to be turned on under a control of a fourth scan signal provided by the fourth scan signal terminal, and transmitting a second bias signal output by the first initialization signal terminal to the control terminal of the driving module and the second terminal of the driving module, wherein the second bias signal is configured to adjust the bias state of the driving module.

32. The driving method according to claim 28, wherein the control terminal of the driving module is electrically connected to a first node, the first terminal of the driving module is electrically connected to a second node, and the second terminal of the driving module is electrically connected to a third node;
the pixel circuit further comprises a threshold compensation module, a control terminal of the threshold compensation module is electrically connected to a third scan signal terminal, a first terminal of the threshold compensation module is electrically connected to the first node, and a second terminal of the threshold compensation module is electrically connected to the third node, and wherein under a control of a third scan signal provided by the third scan signal terminal, the threshold compensation module is configured to connect the control terminal of the driving module and the second terminal of the driving module;
the pixel circuit further comprises a first reset module, a control terminal of the first reset module is electrically connected to a fourth scan signal terminal, a first terminal of the first reset module is electrically connected to a first initialization signal terminal, and a second terminal of the first reset module is electrically connected to the first node or the third node;
the bias stages of the refresh frame further comprise a third bias stage, and the third bias stage is located before the first bias stage;
the driving method further comprises:
in the third bias stage, causing the threshold compensation module to be turned on under a control of the third scan signal provided by the third scan signal terminal, causing the first reset module to be turned on under a control of a fourth scan signal provided by the fourth scan signal terminal, and transmitting a second bias signal output by the first initialization signal terminal to the control terminal of the driving module and the second terminal of the driving module, wherein the second bias signal is configured to adjust the bias state of the driving module.

33. The driving method according to claim 28, wherein the pixel circuit further comprises a second bias module, a control terminal of the second bias module is electrically connected to a fifth scan signal terminal, a first terminal of the second bias module is electrically connected to a second bias signal terminal, and a second terminal of the second bias module is electrically connected to the first terminal or the second terminal of the driving module;
the bias stages of the refresh frame further comprise a third bias stage, and the third bias stage is located before the first bias stage;
the driving method further comprises:
in the third bias stage, causing the second bias module to be turned on under a control of a third scan signal provided by the fifth scan signal terminal, and transmitting a second bias signal output by the second bias signal terminal to the first terminal or the second terminal of the driving module, wherein the second bias signal is configured to adjust the bias state of the driving module.

34. A display panel comprising a pixel circuit, wherein the pixel circuit comprises:
a driving module configured to drive a light-emitting element to emit light;
a first bias module electrically connected to a first terminal or a second terminal of the driving module, wherein the first bias module is configured to provide a first bias signal to the first terminal or the second terminal of the driving module, and the first bias signal is configured to adjust a bias state of the driving module;
wherein a light-emitting cycle of the light-emitting element comprises a refresh frame or a hold frame, wherein a control terminal of the driving module is refreshed in the refresh frame, and the control terminal of the driving module is not refreshed in the hold frame; each of the refresh frame and the hold frame comprises a first stage and a second stage, the first stage is located before the second stage, the first stage comprises one or more bias stages, and the second stage comprises a light-emitting stage of the light-emitting element, and wherein in the bias stages, the first bias module is turned on, and the first bias signal is transmitted to the first terminal or the second terminal of the driving module;
wherein a turn-on duration of the first bias module in the hold frame is longer than a turn-on duration of the first bias module in the refresh frame; and/or,
a time interval between a turn-on start moment of the first bias module in the hold frame and the light-emitting stage in the hold frame is greater than a time interval between a turn-on start moment of the first bias module in the refresh frame and the light-emitting stage in the refresh frame; and/or a turn-on stage of the first bias module in the refresh frame at least partially overlaps with other bias stages in the refresh frame.

35. A display device comprising a display panel, wherein the display panel comprises a pixel circuit, and the pixel circuit comprises:
a driving module configured to drive a light-emitting element to emit light;
a first bias module electrically connected to a first terminal or a second terminal of the driving module, wherein the first bias module is configured to provide a first bias signal to the first terminal or the second terminal of the driving module, and the first bias signal is configured to adjust a bias state of the driving module;
wherein a light-emitting cycle of the light-emitting element comprises a refresh frame or a hold frame, wherein a control terminal of the driving module is refreshed in the refresh frame, and the control terminal of the driving module is not refreshed in the hold frame; each of the refresh frame and the hold frame comprises a first stage and a second stage, the first stage is located before the second stage, the first stage comprises one or more bias stages, and the second stage comprises a light-emitting stage of the light-emitting element, and wherein in the bias stages, the first bias module is turned on, and the first bias signal is transmitted to the first terminal or the second terminal of the driving module;
wherein a turn-on duration of the first bias module in the hold frame is longer than a turn-on duration of the first bias module in the refresh frame; and/or,
a time interval between a turn-on start moment of the first bias module in the hold frame and the light-emitting stage in the hold frame is greater than a time interval between a turn-on start moment of the first bias module in the refresh frame and the light-emitting stage in the refresh frame; and/or a turn-on stage of the first bias module in the refresh frame at least partially overlaps with other bias stages in the refresh frame.
